(19) United States
(12) Patent Application Publication
(10) Pub. No.: US 2026/0098167 A1
(43) Pub. Date: Apr. 9, 2026

(54) DIGITAL PRINTING AND COATING OF FUNCTIONAL MATERIALS

(71) Applicant: ALMA MATER STUDIORUM - UNIVERSITÀ DI BOLOGNA, Bologna (IT)

(72) Inventors: Andreas Stephan Lesch, Bologna (IT); Stefania Rapino, Bologna (IT); Francesco Zerbetto, Bologna (IT); Marco Malferrari, Bologna (IT); Maila Becconi, Bologna (IT)

(73) Assignee: ALMA MATER STUDIORUM - UNIVERSITÀ DI BOLOGNA, Bologna (IT)

(21) Appl. No.: 19/113,996

(22) PCT Filed: Sep. 21, 2023
(86) PCT No.: PCT/IB2023/059334

§ 371 Date: Mar. 21, 2025

(30) Foreign Application Priority Data
Sep. 22, 2022 (IT) 102022000019404

(51) Int. Cl. C09D 11/38; B29C 64/118; B29K 71/00; B29K 105/00; B29L 31/40; B33Y 10/00; B33Y 70/10; B41M 3/00; C09D 11/04; C09D 189/00; G01N 27/327

(52) U.S. Cl. CPC C09D 11/38; B29C 64/118; B33Y 10/00; B33Y 70/10; B41M 3/006; C09D 11/04; C09D 189/00; G01N 27/3271; G01N 27/3277; B29K 2071/02; B29K 2105/0005; B29L 2031/40

(57) ABSTRACT

The present invention relates to a method for forming functional materials, and particularly cross-linked active matrices, for regulating, limiting and blocking oxygen in in vitro cell culturing and packaging for food and beverages, onto a target substrate, as well as to functional substrates obtainable from said methods and kits to be used in said methods.

The present invention relates to a method for forming functional materials, which are in particular cross-linked active matrices, for regulating, limiting and/or blocking oxygen in in vitro cell culturing, or in packaging of food and beverages, and for using oxygen as co-reagent in enzymatic electrochemical biosensors, onto a target substrate, as well as to functional substrates obtainable from said methods and kits to be used in said methods.

### STATE OF THE ART

Digital printing of functional materials comprising active molecules or enzymes is essential to fabricate devices that are of high interest for several industrial sectors and markets.

Fields of application of such functional materials include, for example, the packaging market, wherein printing of functional layers (e.g., oxygen blockage layers) as large, thin, and homogeneous layers onto packaging materials serves for food protection, or the sensor market, wherein in the last the entrapment of active molecules in functional materials is useful for the selective or specific analyte conversion, followed by signal transduction, in biomedical applications, such as for the detection of analytes in food and beverage. Functional materials comprising active molecules may be printed on electrode surfaces (conductive or semi-conductive substrates), insulators and substrates that are transparent or opaque. The substrates can be rigid or flexible, thus the latter includes wearable sensing devices. The transduction of biosensors may be optical, electrochemical, electric, photochemical or it can be based on fluorescence, chemiluminescence or electrochemically generated luminescence. The active materials make the sensors selective and, in case material activity is created by enzymes, specific. Other fields wherein functional materials may find useful application include the cell culturing market, regenerative medicine, drug screening and drug testing as well as the implantable materials field.

Many approaches to immobilize active molecules and enzymes as thin films on substrates exist; however, up to date reliable and accurate methods for the low-cost fabrication of functional materials on industrial scale with large flexibility in patterning designs, layer thicknesses and film composition have been only rarely and non-satisfactorily approached, particularly for the fabrication of enzyme containing devices with a highly controlled activity. Indeed, spatially resolved immobilization of active molecules and enzymes on substrates can often only be achieved using masks/screens or complicated and expensive multistep processes. Major challenges in the field are represented by the synthesis of compact and stable layers of materials with well entrapped or fixed—as well as intact—enzymes.

In this context, there is therefore an urgent need for the development of efficient, low-cost strategies for the fabrication of functional materials, comprising active molecules or enzymes of interest with a high long-term stability, embedded and locally fixed in a thin, flexible film, which could be potentially scaled-up on an industrial level.

### SUMMARY OF THE INVENTION

The technical problem posed and solved by the present invention is that of providing an efficient, low-cost method for the fabrication of functional materials on the surface of a target substrate, which can contain electrostatically, mechanically and/or covalently entrapped (i.e., locally fixed) active molecules or biomolecules, such as enzymes, proteins, or catalysts, with elevated long-term stability, strength, and stiffness.

To this end, the authors of the invention have developed specific fluid compositions (e.g. liquids and gels; hereinafter also named as “inks” or “ink compositions”) and protocols for the deposition of precursors of functional materials to create the said functional materials in situ on a selected substrate as a result of their controlled mixture. Advantageously, the deposition of the compositions developed by the inventors on the selected substrate can be accomplished using different printing or coating techniques, such as inkjet printing (IJP), extrusion printing, aerosol jet printing, slot-die printing/coating, Doctor Blade printing/coating, roll-to-roll printing/coating, screen printing, flexography printing, gravure printing, painting, spray coating, dip-coating, offset printing, micro-contact printing, 3D printing, and nanoimprinting. In all the above cases, one or more controlled fluid delivery systems may be adopted, such as syringes, printheads, extruders, etc., without and with connected microfluidic pumps, fluidic pumps, piezoelectric actuators, etc., to control the volumes of the liquid compositions, and the ratio of different liquids when used in parallel, quasi-parallel, simultaneously, semi-simultaneously, or subsequently, per unit time and per unit substrate area upon deposition (for instance to control the thickness of the films of the active material onto the substrate).

In one particular embodiment, the method of the invention allows for the formation of a cross-linked active matrix onto a substrate of interest, by means of simultaneous or subsequent deposition of at least two fluid compositions. Alternatively, the method of the invention involves pre-mixing of the at least two fluid compositions immediately followed by the deposition of the resulting pre-mixture on the target substrate. The fluid compositions can be in the form of liquid compositions, i.e., solutions (such as aqueous compositions), dispersions or viscoelastic fluids, more precisely gels.

A first object of the invention is hence represented by a method of forming a cross-linked active matrix onto a substrate, comprising the following steps:
(i) providing a first fluid composition comprising at least one cross-linking agent;
(ii) providing a second fluid composition comprising one or more molecules or biomolecules capable of cross-linking with said cross-linking agent;
(iii) depositing the first and second compositions on top of each other onto said substrate by means of simultaneous or subsequent deposition; or (iii′) premixing said first and second compositions followed by depositing the resulting pre-mixture onto said substrate; and
(iv) gelling the compositions or pre-mixture deposited or obtained from step (iii) or (iii′) so as to obtain said cross-linked active matrix onto the substrate.

The at least two distinct fluid compositions employed in the method of the invention react with each other during the gelling step to form an active cross-linked matrix containing embedded active molecules. In one embodiment, the first composition containing at least one cross-linking agent and second composition containing at least one or more active molecules or biomolecules (e.g., enzymes) used in the method of the invention may additionally contain stabilizing agents, such as specific ink stabilizing agents, including polymers or macromolecules that are inert for the final application of the resulting functional material. Preferably, the second composition of the invention further comprises at least one cross-linkable precursor (e.g., a proteins-based precursor) capable of cross-linking with the cross-linking agent, which is advantageous to avoid the denaturation of the active molecules or biomolecules.

In addition, the fluid compositions of the invention may contain one or more additives capable of modifying the viscosity, density and/or surface tension of the liquids. Such addition may be useful so as to ensure that the final compositions fulfil the physicochemical characteristics necessary for the application of a specific printing technology, e.g., inkjet printing using piezoelectric printheads, in terms of viscosity (about 1.1-40 mPa×s) and surface tension (about 25-45 mN/m). The additions enable therefore specific ink deposition protocols by using different printing or coating technologies.

According to one preferred embodiment, the method of the invention is used for printing a functional material possessing a dual enzymatic activity onto a target substrate. This is achieved by immobilizing two enzymes into a protein-based matrix generated by chemical cross-linking upon mixture of two fluid compositions on the target substrate. Preferably, said enzymes are enzymes that are capable of catalyzing the reduction of oxygen, thereby enabling the regulation of oxygen levels within and in the environment of the resulting cross-linked matrix and, consequently, the fabrication of patterned substrates for cell culturing with steady-state oxygen gradients similar to those found in vivo, as well as the fabrication of large thin films as oxygen blocking layer for packaging.

Indeed, as will be illustrated in detail in the following description and experimental section, the formulation of the inks developed by the inventors, as well as the pattern design, can be specifically tuned so as to create controllable oxygen gradients-on demand-on substrates suitable for cell culturing and optical analysis. The capability of spatially controlling the formation of oxygen gradients onto the surface of a target substrate, by forming thereto a suitable active matrix according to any of the methods of the invention, advantageously allows to re-create, under culture conditions, the cell microenvironment existing in vivo. Indeed, the authors of present invention have shown not only that the cell culture environment can be controlled by the herein described methods and resulting matrixes and modified substrates, but also that the conditions which one succeeds in creating are very similar to those existing in a tissue, both normal and tumour tissue. The correct functionality of the printed functional material, in such specific case two parallel enzymatic reactions, has been confirmed by the inventors through laboratory experiments, which are reported in the experimental section of the present specification.

The invention results to be advantageous since the use of the functional materials obtainable by the methods disclosed herein allows to reproduce in vitro the specific physiological conditions and to study the relative cell metabolism, for example the effects of the environment on the metabolism, the cell signaling, the gene expression, both of healthy and tumor cells; moreover it allows to estimate the tumor growth factors and, based thereupon, to devise more effective therapeutic strategies. The functional materials according to the present invention represent unique systems for pre-clinical investigations, as reliable as the in vivo systems but with all advantages of the in vitro systems.

According to another preferred embodiment, the method of the invention is used for printing a functional material possessing an enzymatic activity onto a target substrate that can be an electrochemical cell or substrate containing one, two or three electrodes sensors, thus forming an electrochemical biosensor. Preferably, said enzyme is an enzyme that is capable of catalyzing the reduction of oxygen with simultaneous oxidation of an analyte of interest, thereby enabling the quantitative, qualitative and selective detection of the analyte. In this case, the analyte represents the substrate of the enzymatic system. The enzymatically catalyzed oxidation of the analyte with contemporary reduction of oxygen can lead to the formation of hydrogen peroxide. The electrochemical reduction or oxidation of hydrogen peroxide on a suitable electrode material, e.g., gold and platinum, present as bulk metals, nanoparticles, nanostructured or mesoporous, or alloys of gold and platinum, Prussian-Blue-coated electrodes, results in an electrochemical signal proportional to the analyte concentration.

Thanks to the specific combination of technical features that will be disclosed in the present description and in the claims, the methods developed by the authors of the invention offer additional important advantages.

One first advantage lies in the possibility of forming, on a target substrate, functional materials possessing convenient physical and chemical properties, such as strength, stiffness, adhesion to various substrates, and stability, particularly in solution, which make them suitable for a large variety of applications in various platforms and devices.

As already mentioned, in one embodiment of the invention, digital printing or coating technologies such as inkjet printing may be used for the deposition of the fluid compositions on the selected substrate, advantageously enabling a highly accurate deposition and precise control of the micrometric spatial resolution and structuration (e.g., lateral dimensions, homogeneity and sub-micrometric thickness) of the resulting active molecule-containing matrix on the substrate.

At the same time, the methods of the invention ensure a precise control of the amount of active molecules or biomolecules in the resulting matrix, without affecting the functionality of said molecules or biomolecules, which is a key advantage when enzymes are used. The thickness of the functional materials and thus of enzymatic activity is highly controllable by the number of droplets or ink volume deposited per area (dpi-drops per inch; or ink volume per inch) leading in particular to thin homogenous films with controlled activity.

Notably, as mentioned above, in case enzymes are used as active biomolecules, the methods of the invention allow to preserve their enzymatic activity not only in the fluid compositions but also in the resulting functional material formed onto the target substrate. The fluid compositions used in the methods of the invention, as well as the functional materials obtainable from said methods, may be also biocompatible and can be stored for extended periods. It has been in fact verified that the compositions of the invention as well as the resulting functional materials can be stored for months without losing its chemical and mechanical functions.

Another important advantage of the methods of the present invention lies in their capability of enabling patterning of functional materials (e.g., of a cross-linked active matrix) on the target substrate. This can be accomplished, for example, by forming laterally resolved micrometric features, such as grids, lines, spot arrays, circles, or other specific shapes as well as by printing large or micrometer-thin homogeneous film coatings on the substrate. The resulting functional materials can also be placed between two distinct substrates, i.e., being sandwiched between two substrates (e.g., plastic foils, biomaterial foils, paper sheets or glass slides), but can also be part of multi-layered films in general. As such, the present invention offers a fast, mask-less, and effective method for prototyping devices/materials and for the industrial production/fabrication of such devices.

Printing automation and use of digital platforms for printing, together with digital pattern design, enables low-cost on-demand production of functional materials for several different applications. Indeed, the printed functional materials obtainable by the methods of the invention can find immediate application with no need for any post-treatment application (e.g., UV- or thermally-based cross-linking).

The possibility of selecting among a large variety of different biomolecules including enzymes to be entrapped in the functional material resulting from the methods of the invention make such methods extremely flexible and tunable according to the specific application of interest. Functional materials can be printed on demand, and specific devices incorporating the desired functional materials can be fabricated as needed by the end users. This can include different enzymes in different concentrations with local variations of these two parameters creating thus in a form of an enzyme library arrays of spots of varying enzymatic activities. This flexibility may solve many issues in biotechnological, biomedical, and food/beverage-related applications.

The methods of the invention are also very rapid, as the formulation and on-substrate depositing and mixing of the ink compositions of the invention make them react to form the functional material onto the target substrate directly in situ, by means of a one-step synthesis process. On-substrate crosslinking of the liquid ink compositions, once having been deposited on the target substrate, avoids the problem of clogging of the orifices of printing devices (nozzles, plastic tips, etc.), which generally occurs when it is aimed to deposit pre-formed polymer particles.

Moreover, the methods of the invention allow the formation of the functional materials through spontaneous chemical reactions at room temperature. Key advantages over competing technologies and competing functional materials lie in that no UV light or heat is necessary to generate the resulting matrix on the substrate. Therefore, the proposed technology is not affected by the degradation of the active molecules, e.g., by UV light or heat, especially when using enzymes.

The methods of the invention are particularly adoptable and integrable into a wide range of printing technologies including automated and semi-automated large-scale processes. Of relevance is the fact that all the materials used in the methods of the invention can be obtained in large volumes at low cost. Minimum volumes of the liquid compositions can be used without waste when drop-on-demand inkjet printing or extrusion are used. This suggests high profit margins.

More importantly, the methods of the present invention, particularly when based on the implementation of digital printing technologies for the deposition of the ink compositions, enable the production of structured functional materials both on a small scale (R&D level) and on a large-scale (industrial production level); indeed, all the methods disclosed in the present application are up-scalable to large industrial fabrication levels, by using the same deposition technology, but with larger dimensions (e.g., number of printheads in an inkjet printhead or the length of slot die head), thus making the methods very attractive for the industry.

Other advantages of the invention will be apparent from the following detailed description of preferred embodiments of the invention.

### DETAILED DESCRIPTION OF THE FIGURES

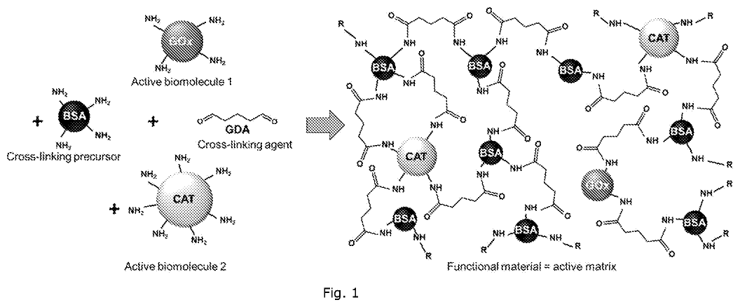

FIG. 1. Schematic representation of the protein-based functional material: BSA, GOx and CAT are cross-linked by GDA through the formation of amide groups.

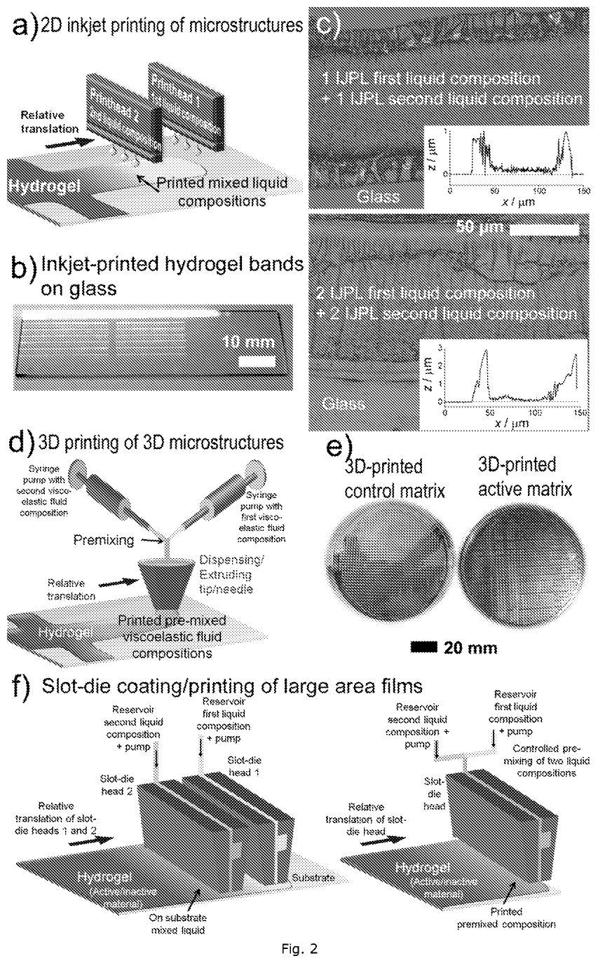

FIG. 2. Functional material printing with three exemplary techniques. a) Schematic representation of parallel inkjet printing of first fluid composition (ink 1—“cross-linker ink”) and second fluid composition (ink 2—“protein ink” or “active biomolecule ink”) to generate immediately patterns of cross-linked active material on a substrate by the on-substrate mixing of the inks 1 and 2 a. b) 2D lines with micrometer widths of inkjet-printed (IJP) functional material on glass slides. c) Laser scanning optical micrographs and height profile analysis (inserts) of one 100 μm wide band of the functional material obtained by inkjet printing with three consecutive nozzles of a piezoelectric printhead on the glass slide. Functional matrix' precursor loadings on the substrate were ˜117 (˜234) ng/mm² GOx, ˜234 (˜468) ng/mm² CAT, ˜914 (˜1828) ng/mm² BSA and ˜137 (˜274) ng/mm² GDA for a 1 (2) IJP-layer (IJPL) process. d) Schematic representation of dispensing/extruding a mixture of the first and second viscoelastic fluid compositions (“premixed viscoelastic fluid” or “pre-mixed viscoelastic fluid compositions”) obtained by mixing first and second viscoelastic fluid compositions with two syringes immediately before entering the tip of the printing device. e) Photos of patterns of 3D-printed control matrix and 3D-printed active matrix. f) Schematic representation of slot-die coating using two separate slot-die heads filled with first and second liquid compositions for semi-simultaneous deposition (left panel) and slot-die coating with one slot-die head filled with the premixed first and second liquid compositions just before printing.

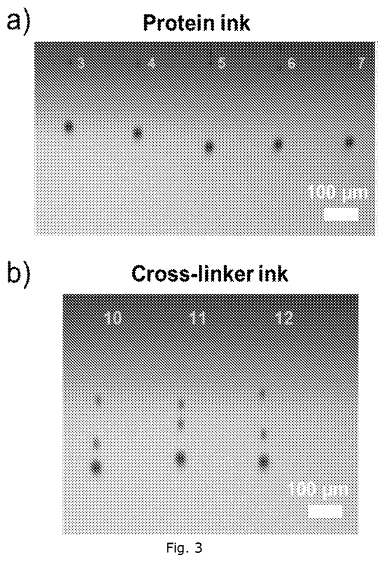

FIG. 3. Visualization of exemplary droplets generated with the piezoelectric printheads (Fujifilm Dimatix DMC-11610 cartridge) and by using the integrated droplet visualization camera of a Ceraprinter X-Serie: a) “Protein ink” (five active nozzles). b) “Cross-linker ink” (three active nozzles).

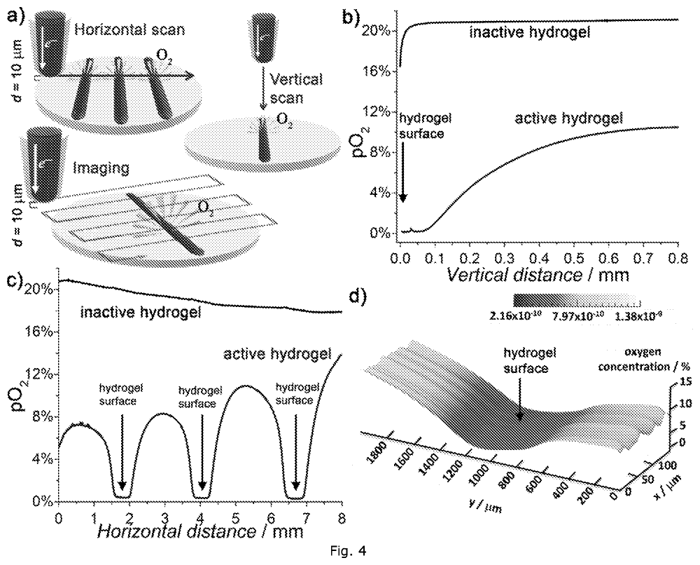

FIG. 4. Scanning electrochemical microscopy functional investigation of the oxygen microenvironment generated in a cell culture dish with an exemplary patterned functional material. All measurements were performed using a 10 μm Pt ultra-microelectrode (UME) at −0.7 V vs Ag/AgCl (KCl 3 M) in Phosphate Buffered Saline (PBS) solution (see the Methods section for a detailed description). a Schematic representation of the performed SECM measurements. Horizontal scan: SECM lateral scan at constant height (approximately 10 μm from the Petri dish surface) over the culturing microenvironment generated by parallel patterned lines of the functional material; Vertical scan: SECM approach curve on a patterned line of the functional material; Imaging: SECM image of the generated oxygen microenvironment at constant height (approximately 10 μm from the Petri dish surface). b) SECM approach curve on control inactive matrix (“inactive hydrogel”) and on active functional matrix (“active hydrogel”), both the active and inactive matrixes are patterned on Petri dishes, the curves were recorded in PBS solution in presence of 10 mM glucose (please refer to scheme 5b). c) Constant height SECM lateral scan of parallel patterned lines of the functional material before and after the addition of 10 mM glucose in the PBS buffer (please refer to scheme 5a). d) SECM image of the oxygen microenvironment present in a Petri dish and generated by patterned lines of the functional material, 10 mM glucose in PBS.

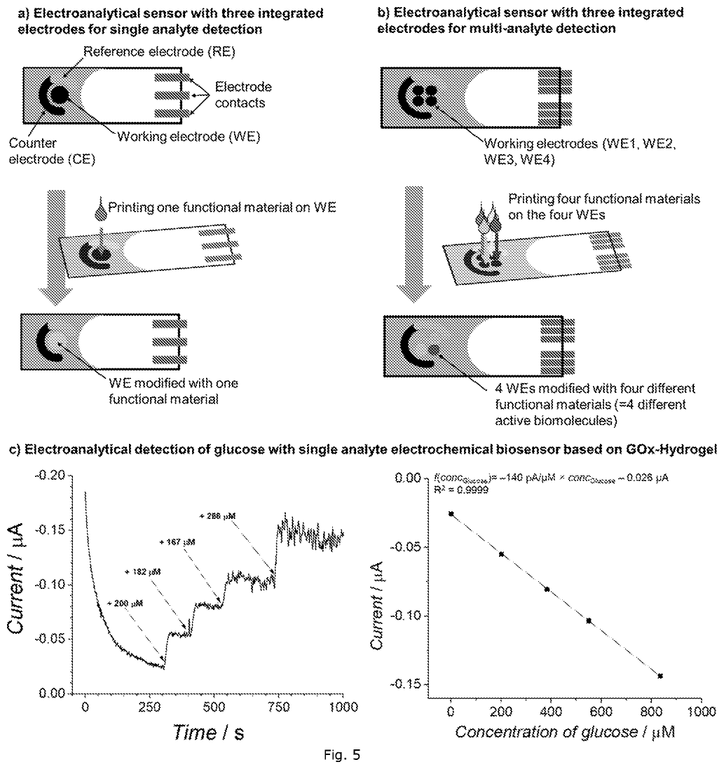

FIG. 5. Schematic representation of the functionalization of one or more working electrodes of electrochemical sensors with the functional material to form single (a) or multi (b) enzymatic electrochemical biosensors. (c) Exemplary measurement for the electrochemical detection of glucose with a biosensor coated with the functional material containing GOx (left: chronoamperometric measurement; right: resulting calibration graph). The chronoamperometric measurement was performed in PBS solution with a modified DropSens 250AT screen-printed electrode, biased at +0.65 V vs quasi-reference silver electrode; modification of the gold working electrode is detailed in the text (see Example 3). Arrows indicate the timing of four successive glucose additions to the starting PBS solution; for each addition the increase of glucose concentration is reported in the Figure.

### Glossary

In the context of the present description, the term “functional material” or “active material” is used to identify any type of active matrix or material incorporating, absorbing/adsorbing or, in particular, containing electrostatically, mechanically and/or covalently entrapped (i.e., locally fixed) active molecules or biomolecules, such as, without limitation, enzymes, peptides, proteins, or catalysts. “Functional material”, “active material” and “active matrix” may hence be used as synonyms in the present specification and in the claims.

According to the invention, a “cross-linked active matrix” obtainable by any of the methods of the present inventions represents a “cross-linked functional material” or a “cross-linked active material”. Moreover, under “active matrixes” materials are meant which, once formed on a suitable substrate (for example the plastic of a culture plate) through linking and thus locally fixing the active biomolecules, e.g., enzymes, could perform their function/activity in a stable, spatially controlled manner. According to the present invention, the functional material is preferably a “hydrogel” as it contains water, specifically an “active hydrogel” when containing the active molecules or biomolecules. Therefore, anywhere in the present specification, the terms “active material” and “functional material” can be replaced by “active hydrogel” and “functional hydrogel”, respectively.

The term “active” is particularly used herein to designate all matrixes or functional materials containing or comprising “active molecules or biomolecules” such as, without limitation, proteins, peptides, enzymes, or catalysts exerting or exhibiting a specific biological activity, e.g., a specific enzymatic activity such as the capability of catalyzing the reduction of oxygen by oxygen reducing enzymes as their main or secondary reaction. In other words, the biomolecules should not be in denatured form inside the fluid compositions and the resulting matrix as disclosed herein, but in their catalytically active form.

The term “inactive” is used herein to designate all those matrixes or materials that do not contain or comprise any “active molecule or biomolecule” for the target application, e.g., the reduction of oxygen; in the context of the invention the expressions “inactive matrixes” or “inactive materials” may hence encompass either matrixes or materials not comprising nor including any active molecules or biomolecules such as proteins, enzymes or catalysts, exerting or exhibiting a specific biological activity, but also matrixes or materials comprising “inactive molecules or biomolecules”, namely molecules or biomolecules that have lost their native biological activity or that have been specifically inactivated so as to suppress or hinder their native activity, e.g., denatured or modified to suppress or hinder their enzymatic activity, for the target application, e.g. the reduction of oxygen. The material may contain active molecules for side reactions.

The expressions “inactive matrixes” or “inactive materials” may further encompass either matrixes or materials comprising active molecules or biomolecules according to any of the embodiments disclosed in the present specification, which molecules or biomolecules are not activated, hence do not exert, or exhibit a specific biological activity due to the absence of specific activating molecules, substrates and/or reagents.

An example of “inactive matrix” according to the present specification is represented by a cross-linked “control” matrix not including any enzyme capable of catalyzing the reduction of oxygen. Such inactive matrixes can be used as controls.

The wording “control matrix” may hence be used in the present specification and in the claims to replace or as a synonym of the expression “inactive matrix”, always referring to the reaction of interest, e.g., the reduction of oxygen. Also, an inactive matrix according to any of the variants disclosed in the present specification forms a “hydrogel”, which can be also named as an “inactive hydrogel”. The terms “substrate” or “target substrate” are used as synonyms in the context of the present application to designate a suitable substrate or support selected for performing a method according to any of the embodiments of the invention. Suitable examples of such substrates are as provided in the following detailed description or in the appended set of claims.

As used herein, the expressions “cross-linking” or “capable of cross-linking” or “capable of being cross-linked” refer to the capability of one agent of linking to another molecule, such as a cross-linking agent to the cross-linkable precursor or one or more molecules or biomolecules used in the compositions of the invention, by forming covalent bonds. As such, the cross-linking agent, as well as the cross-linkable precursors and one or more active molecules possess specific functional groups allowing covalent bond formation upon cross-linking between each other. The term “cross-linking agent” specifically includes any agent able to introduce a crosslink between the chains or functional groups of the cross-linkable precursor (e.g., a protein) and one or more functional groups of the active molecules or biomolecules (e.g., enzymes) that are present in the compositions of the invention.

In the context of the invention, the terms “fluid(s)” or “fluid composition(s)” encompass compositions or inks in a form selected from liquid compositions, i.e., solutions (such as aqueous compositions), dispersions or viscoelastic fluids (more precisely gels); such liquid compositions, dispersions or viscoelastic fluids (more precisely gels), preferably possess physiochemical and mechanical properties that make them suitable for printing by means of any of the printing techniques disclosed in the present specification.

Anywhere in the present specification and in the claims the wording “fluid compositions” may be replaced by the wording “inks” or “ink compositions” or “ink formulations” or “pastes” or “liquid compositions” or “solutions” or “dispersions”.

In the present description under the term “for in vitro cell culturing” it is meant to be suitable to be used with cell cultures, in particular eukaryotic cell cultures and more in particular human cell cultures and primary cell cultures. To belong to this definition then biocompatible functional materials, matrixes, compositions, gels, or hydrogels are meant, preferably which do not form toxic products for the cells.

In the context of the invention, the term “inkjet printing” refers to a type of computer printing that involves the ejection of droplets of a printing liquid composition or inkjet ink or simply ink, such as those according to any of the embodiments defined in the present application and in the claims, onto a substrate or support. Typically, printheads using e.g., piezoelectric crystals, are used to deposit the droplets on the substrate. Generally, there are two main technologies in use in contemporary inkjet printing processes: continuous inkjet (CIJ) and Drop-on-demand (DOD) inkjet printing. Drop-on-demand IJP is a broad classification of the inkjet printing technology where drops are ejected from the print head only when required. The drops are formed by the creation of a pressure pulse within the fluid chamber next to the nozzle of the print head ejecting a droplet of ink through the nozzle orifice. The primary sub-categories within DOD derive from the particular method used to generate this pressure pulse, mostly thermal and piezoelectric (piezo). With piezo DOD, a piezoelectric crystal undergoes distortion, more precisely expansion or deformation, when an electric field via a voltage pulse is applied. This distortion creates a pressure pulse in the ink chamber within the printhead, which in turn, causes an ink droplet to be ejected from the nozzle onto the substrate.

Herein, the term “spray painting” or “spray coating” or “spray printing” have the same meaning and are used interchangeably. They refer to a printing/painting technique where a device sprays a liquid composition or ink according to any of the embodiments of the present invention through the air onto a substrate. The most common types employ compressed gas, usually compressed air, to create a spray of fine particles in a vacuum or a surrounding gas and direct the particles of the compositions.

The term “screen printing” refers to a printing technique that typically uses a screen made of a woven mesh onto which an ink-blocking stencil is applied. The stencil typically has openings through which an ink according to any of the embodiments of the inventions can penetrate the screen and be transferred onto, for example, a substrate underneath the screen. A fill blade or squeegee is typically moved across the screen stencil, forcing the ink through the mesh openings to wet the substrate during the squeegee stroke. It should be noted that the application of a print pattern onto a substrate using screen printing is not limited to the use of a woven mesh with a stencil as described above, and other screens, stencils or screen-printing techniques known in the art can be used to form a patterned matrix according to the invention onto a substrate.

In the context of the present description, “about” refers to the experimental error that can occur during conventional measurements. More particularly, when referring to a value it indicates ±5% of the indicated value.

Anywhere in the present description and in the claims, the word “comprising” may be replaced by the word “consisting of”.

### DETAILED DESCRIPTION OF THE INVENTION

As previously mentioned, a first object of the present invention is represented by a method of forming a cross-linked active matrix onto a substrate, comprising the following steps:
(i) providing a first fluid composition comprising at least one cross-linking agent;
(ii) providing a second fluid composition comprising one or more active molecules or biomolecules capable of being cross-linked with said cross-linking agent;
(iii) depositing the first and second compositions on top of each other onto said substrate, by means of simultaneous or subsequent deposition; or (iii′) premixing said first and second compositions followed by depositing the resulting pre-mixture onto said substrate; and
(iv) gelling the compositions or pre-mixture deposited in step (iii) or (iii′) so as to obtain said cross-linked active matrix onto the substrate.

In step (iii) of a method according to any of the embodiments disclosed in the present specification, depositing the first and second fluid compositions on top of each other onto the substrate leads to their immediate or instantaneous mixing, thus to their homogenization. In other terms, in step (iii) depositing the first and second fluid compositions on top of each other onto the substrate leads to the formation of a homogeneous mixture of said compositions.

### Fluid Compositions or Inks

Suitable active molecules or biomolecules that can be used in a second fluid composition according to the present invention include any kind of molecule or biomolecule known in the art that is capable of exerting or exhibits a desired biological or catalytic activity. Non-limiting examples of active biomolecules include proteins, peptides, enzymes, catalysts, nucleic acids including oligonucleotides, DNA, RNA, and nucleic acid analogues, antigens, viruses, virus-like particles and other types of biomolecules having biological activity in general, like e.g., antibodies.

The active molecules or biomolecules described herein can be, in a preferred embodiment, enzymatically active substances or agents, such as enzymes capable of catalyzing reactions in biological systems. Most known enzymes are proteins, but other biomolecules, such as catalytically active RNA, can also function as enzymes and are included in the scope of this definition. Examples of classes of enzymes that might be included in a liquid composition according to the present invention include oxidases, peroxidases, kinases, phosphatases, proteolytic enzymes, GTPases, ATPases, polymerases, RNases, DNases, and more generally oxidoreductases, transferases, hydrolases, lyases, isomerases, and ligases. Some enzymes require more than one protein molecule to be active (i.e., multimeric enzymes). In such cases, the complex as a whole is termed an enzyme unless specified otherwise.

In one preferred embodiment of the invention, the one or more active molecules or biomolecules that can be employed in a fluid composition such as those disclosed in the present specification and in the claims are enzymes capable of catalyzing the reduction of oxygen.

The enzymes included in the herein described compositions and resulting matrixes could be, for example, enzymes that consume O₂ by its reduction preferably enzymes consuming O₂ without forming toxic products for living cells or other compounds and species being in contact with the functional material in their applications. To this end, the herein described compositions could include even a second enzyme which removes/consumes the toxic product produced by the first enzyme.

Preferably, the enzymes are active in the compositions and resulting active matrix that is formed onto the selected substrate for a period sufficient for cell cultivation, for example 12, 24, 48 or 72 hours, in other words the enzymes are not in denatured form inside the resulting matrix, but in their catalytically active form. As will be further shown in the present description and section of the examples, the retention of the enzymes' capability of consuming oxygen in the resulting matrix, allows to generate a pattern that enables to control the oxygen gradient in the in vitro cell cultures and/or to remove and block oxygen as an oxygen barrier in packaging applications, or to catalytically oxidize an analyte, which represents the substrate of the first enzyme, for the quantitative and qualitative, thus specific, detection of the analyte using electrochemical biosensors.

A second fluid composition that may be used in a method according to the present invention preferably comprises one or more enzymes capable of catalyzing the reduction of oxygen selected from Glucose oxidase (GOx), galactose oxidase, Laccases, NADPH oxidase, xanthine oxidase, lactate oxidase, cytochrome oxidase, any oxidase and oxidoreductase using oxygen as substrate, and mixtures thereof.

According to a preferred embodiment the second fluid composition includes Glucose oxidase. Glucose oxidase -GOx- is an enzyme of the family of oxidoreductases which catalyses the following reaction:

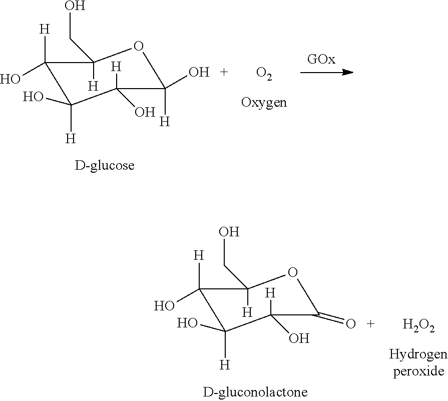

Hydrogen peroxide is a very reactive molecule, a reactive oxygen species (ROS), toxic for cells in high concentrations, for this reason it is preferred and, in cases when cellular viability needs to be preserved, even necessary to couple the above enzymatic reaction to that of Catalase-CAT-, another very important oxidoreductase in the biological systems, which transforms the ROS species produced directly into water.

Hence, in one preferred embodiment, the second composition used in any of the methods of the invention further comprises catalase (CAT), preferably comprises both GOx and CAT.

Alternatively, or additionally, other peroxidases can be present in the second composition of the invention to remove catalytically the hydrogen peroxide produced in the oxygen reduction reaction, for example peroxidases, such as Horseradish peroxidase (HRP) can be used.

The combination of GOx and CAT in the second composition according to any of the embodiments of the invention allows obtaining a resulting cross-linked active matrix offering two different functions: i) the capability of regulating the local oxygen contents and spatially generating oxygen concentration gradients on the target substrate; ii) the capability of scavenging a cell toxic by-product generated by the material functioning itself.

In one embodiment, the concentrations of active molecules or biomolecules, and particularly the enzymes to be used in the liquid compositions of the invention can be provided by means of simulations, which employ master equation or by means of finite element simulations in order to determine specific pattern designs, local concentrations and oxygen gradients that are desired in the resulting cross-linked matrix, namely in the resulting cell culture environment.

According to one embodiment, the first composition that is used in any of the methods of the invention may comprise any cross-linking active agent known in the art, which possess suitable functional groups that enable covalent bond formation with the selected one or more active biomolecules from the second liquid composition.

In one aspect, the first composition that is used in any of the methods of the invention comprises at least one cross linking agent selected from glutaraldehyde (GDA), Bis(sulfosuccinimidyl) suberate, N-hydroxysuccinimide, formaldehyde, and photoreactive agents. Preferably, said at least one cross-linking agent is GDA.

In another aspect, the second composition according to any of the embodiments disclosed herein further comprises a suitable cross-linkable precursor possessing the capability of cross-linking with the cross-linking agent used in the first composition. It is preferred that said cross-linkable precursor is a protein-based cross-linkable precursor.

A preferred example of cross-linkable precursor is represented by Bovine Serum Albumin (BSA). During the formation of the cross-linked matrix, the presence of a cross-linkable precursor such as Bovine Serum Albumin (BSA) is advantageous to avoid the denaturation of the active molecules or biomolecules, e.g., enzymes, during cross-linking and gelling/formation of the matrix and application of the matrix.

Even more preferably, using elevated concentrations of BSA allows the formation of many cross-links among the BSA molecules, and between the BSA molecules and enzyme molecules in the presence of the cross-linking agent: in this way the concentration of the “active” enzymes, i.e., active for a target molecule, can be reduced or increased to the quantities required by the specific application without the risk that the enzyme is not fixed in the matrix if being present at very low concentrations. The presence of BSA also decreases the probability of intermolecular cross-links in the “active” enzymes which could denature them by inhibiting their activity.

According to one embodiment, any of the fluid compositions that can be used in a method according to the present invention further comprise at least one additive chosen among stabilizing agents, preservatives, protease inhibitors, pigments, diluents, pharmaceutically acceptable excipients, binders, lubricants, surfactants, and mixtures thereof.

Suitable stabilizing agents encompass polymers or macromolecules that are inert for the final application of the resulting cross-linked active matrix, which may enable, for example, a specific ink deposition by different printing or coating technologies, e.g., inkjet printing stabilizing agents.

In one aspect, the compositions according to any of the embodiments of the invention further comprise one or more stabilizing components selected from the group consisting of a pH buffer, an acrylic-based crosslinking molecule, a disulfide bond reducing agent, a divalent ion chelating agent, a protease inhibitor, a salt, a sugar, and a biocide.

The compositions may optionally include a pH buffer selected from the group consisting of sodium barbital, HEPES, PIPES, MES, MOPS, Tricine, BIS-TRIS, phosphate, phosphate-saline, SSC, SSPE, TAPS, TAE, TBE and combinations thereof. To obtain an optimal enzyme activity in the compositions of the present invention, it is advantageous to use a pH less than pH 8.0. In some embodiments the pH of the compositions of the present invention is from about 5.0 to about 7.5. The pH of the compositions may be maintained in that range by using well known buffers. An exemplary buffer includes, but is not limited to 100 mM TRIS, at pH 7.6. TRIS buffers with varying ionic strengths ranging from 10 to 200 mM can also be used in the pH range from about pH 6.5 to about 8.0.

In certain aspects, any of the fluid compositions that can be used in a method of the present invention further comprise at least one biocompatible additive selected from additives known in the art capable of modifying the viscosity, density, and/or surface tension of fluid compositions. Such additives may be useful to ensure that the fluid compositions fulfil the physicochemical characteristics necessary for the application of a specific deposition technology in terms of viscosity and surface tension, e.g., printing or coating techniques such as inkjet printing using piezoelectric-based printheads. In one embodiment, said at least one biocompatible additive is selected from Pluronic F-127, Triton X-100 and mixtures thereof.

It is preferred that a composition according to any of the embodiments disclosed herein contains a suitable amount of an agent capable of modifying the viscosity of the composition, in particular Pluronic F-127, but also other poloxamers known in the art, so as to achieve a viscosity ranging between 1.1 to 40 mPa×sec, preferably equal to about 1.2 or 1.3 mPa×sec as for example for inkjet printing.

It is preferred that for deposition techniques like inkjet printing a composition according to any of the embodiments disclosed herein contains a suitable amount of an agent capable of modifying the surface tension of the composition, in particular Triton X-100, so as to achieve a surface tension ranging between 25 to 45 mN/m, preferably equal to about 30 nM/m.

In another aspect, the compositions according to any of the embodiments disclosed in the present specification and in the claims further comprise one or more additives known in the art to be suitable for cell culturing, such as one or more additives selected from diluents, nutrients and/or culture media, pH stabilizers, preservatives, antibiotics.

In a preferred aspect of the invention, the fluid compositions according to any of the embodiments disclosed herein are viscoelastic compositions (i.e., gels) or liquid compositions, preferably are liquid compositions.

The first and second compositions that can be used in a method according to the present invention are preferably aqueous compositions, preferably comprise only water as solvent. Such liquid compositions may be prepared according to any of the techniques known to a person skilled in the art, e.g., by adding a proper amount of the cross-linking agent and one or more active biomolecules, such as enzymes exemplified above, respectively, (and optionally one or more cross-linkable precursors and/or additives such as those mentioned in the present specification) in a suitable amount of an aqueous solution so as to reach the desired concentration. Based on the selected cross-linking agents, cross-linkable precursors and specific molecules or biomolecules/enzymes, a person skilled in the art will know which solvent to select so as to allow a proper dissolution of the desired amount of such compounds. Preferably, the liquid compositions of the invention comprise a solvent composed by 100% of water, e.g., deionized, or distilled water.

The concentration of the enzymes in the resulting active matrix can vary depending on the formulation of the inks and on the parameters used for their deposition on the target substrate, e.g., on the selected digital printing or coating technique used for their deposition on the substrate.

Depending on the type of deposition technique of the liquid composition onto the target substrates used in the methods of the invention, as well as on the specific application of the resulting functional materials (i.e., the active matrix), a person skilled in the art will be able to determine the suitable concentrations/amounts of cross-linking agents, cross-linkable precursors and specific molecules or biomolecules (e.g. enzymes), respectively, to be used in the liquid compositions of the invention in order to obtain an active matrix possessing the desired physical-chemical properties.

In one embodiment, the first composition used in the method of the invention according to any of the variants disclosed in the present specification and in the claims is an aqueous composition comprising GDA, Pluronic F-127 and Triton X-100.

According to a preferred embodiment, GDA is present in said first composition in an amount ranging from 1 to 40 μL/mL, preferably equal to 10 μL/mL to 28 μL/mL, of a 25 wt. % GDA solution; Pluronic F-127 is present in an amount ranging from 5 to 300 mg/mL, preferably equal to 25 mg/ml to 250 mg/mL, and Triton X-100 is optionally present in an amount ranging from 0.09 to 0.5 L/mL, preferably equal to 0.375 μL/mL if the surface tension must be reduced.

According to one preferred embodiment, if, in said step (iii) or (iii′) of a method according to any of the embodiments herein disclosed, depositing is accomplished by inkjet printing, said first composition comprises GDA in an amount equal to 10 μL/mL, Pluronic F-127 in an amount equal to 25 mg/mL and Triton X-100 in an amount ranging from 0.09 to 0.5 μL/mL, preferably equal to 0.375 μL/mL.

According to another preferred embodiment, if, in said step (iii) or (iii′) of a method according to any of the embodiments herein disclosed, depositing is accomplished by extrusion printing, said first composition comprises GDA in an amount equal to 28 μL/mL of a 25 wt. % GDA solution in water, and Pluronic F-127 in an amount equal to 250 mg/mL.

Preferably, said first composition is prepared by adding a proper amount of each component in the above-mentioned ranges to water.

In one embodiment, the second composition used in the method of the invention according to any of the variants disclosed in the present specification and in the claims is an aqueous composition comprising BSA as a protein-based cross-linkable precursor, together with GOx, CAT and, optionally, Triton X-100. According to a preferred embodiment, said second composition comprises BSA in an amount ranging from 15 to 250 mg/mL, preferably equal to 31.25 mg/mL to 128 mg/mL, GOx in an amount ranging from 2 to 32 mg/mL, preferably equal to 4 mg/ml to 16 mg/mL, CAT in an amount ranging from 4 to 64 mg/mL, preferably equal to 8 mg/ml to 32 mg/mL, and Triton X-100 optionally in an amount ranging from 0.09 to 0.5 μL/mL, preferably equal to 0.375 μL/mL. According to one preferred embodiment, if, in said step (iii) or (iii′) of a method according to any of the embodiments herein disclosed, depositing is accomplished by inkjet printing, said second composition comprises BSA in an amount equal to 31.25 mg/mL, GOx in an amount equal to 4 mg/mL, CAT in an amount equal to 8 mg/mL and Triton X-100 in an amount ranging from 0.09 to 0.5 μL/mL, preferably equal to 0.375 μL/mL.

According to another preferred embodiment, if, in said step (iii) or (iii′) of a method according to any of the embodiments herein disclosed, depositing is accomplished by extrusion printing, said second composition comprises BSA in an amount equal to 128 mg/mL, GOx in an amount equal to 16 mg/mL, and CAT in an amount equal to 32 mg/mL.

Preferably, said second composition is prepared by adding a proper amount of each component in the above-mentioned ranges to water.

It is preferred that the second liquid composition according to any of the variants disclosed in the present specification and in the claims further comprises a defined amount of a cross-linking agent, which is preferably the same agent used in the first composition. The addition of such defined amount of cross-linking agent in the second composition results in a controlled cross-linking of a small portion of the matrix precursors, including the active enzymes, thereby increasing the viscosity of the second composition itself.

In one preferred embodiment, the second composition according to any of the variants disclosed herein hence further comprises a defined small amount of a cross-linking agent, preferably GDA, even more preferably in an amount ranging from 0.1 to 5 μL/mL of a 25% GDA solution in water. Even more preferably, said second liquid composition comprises GDA in an amount equal to 1 μL/mL of a 25% GDA solution in water. Such specific addition initiates a controlled and restricted minor pre-cross-linking of BSA, GOx and CAT just to provide a controlled increase of the viscosity of the composition up to about 1.2 mPa×sec, without the necessity to add compounds like Pluronic F-127. However, also poloxamers could be added to increase the composition viscosity. In such case, Pluronic F-127 is present in an amount ranging from 5 to 300 mg/mL, preferably equal to 25 mg/mL to 250 mg/mL.

According to one embodiment, the compositions disclosed in the present specification and in the claims possess a shelf life, i.e., a stability, of at least 12 months. It is however preferred that such compositions are stored at a temperature of maximum 4° C.

According to a preferred embodiment of the invention, the method comprises step (iii′) and, in said step (iii′), said first and second compositions according to any of the variants herein discloses are pre-mixed resulting in a pre-mixture comprising an amount ranging from 1 to 40 L/mL of a 25 wt. % GDA solution in water, preferably equal to 14 μL/mL 25 wt. % GDA solution; Pluronic F-127 in an amount ranging from 5 to 300 mg/mL, preferably equal to 250 mg/mL; BSA in an amount ranging from 15 to 250 mg/mL, preferably equal to 64 mg/mL; GOx in an amount ranging from 2 to 32 mg/mL, preferably equal to 8 mg/mL, CAT in an amount ranging from 4 to 64 mg/mL, preferably equal to 16 mg/mL.

A further object of the present invention is represented by a fluid composition or combination of fluid compositions, and particularly fluid compositions for inkjet printing, according to any of the embodiments disclosed in the present specification and in the claims.

### Deposition Techniques

As previously mentioned, the deposition of the first and second fluid compositions according to the present invention, or of the resulting pre-mixture in cases when such compositions are mixed before deposition, can be accomplished by using any printing or coating technique known in the art, e.g., 2D (two-dimensional) printing, or 3D (three-dimensional) printing. The term “2D-printing” refers to the process of depositing an essentially two-dimensional composition onto a substrate. The “3D printing” process involves a process of making a three-dimensional solid active matrix/material of virtually any shape starting from a digital model. Building up the solid active matrix/material is typically realized by means of an additive process in which successive layers of the liquid compositions of the invention are laid down in the same or different shapes, using for instance an extrusion printer.

Preferably, depositing is accomplished by means of a digitally controlled printing or coating technique where digitally refers to process in which the amount of the composition per area, the deposition design and the speed of deposition are fully controlled by using a personal computer and software. According to one aspect, depositing is accomplished by a printing or coating technique, such as a digitally controlled printing or coating technique, selected from: inkjet printing, extrusion printing, aerosol jet printing, slot-die printing or coating, Doctor Blade printing or coating, roll-to-roll printing or coating, screen printing, flexography printing, gravure printing, painting, spray coating, dip-coating, offset printing, micro-contact printing, 3D printing and nanoimprinting.

In one preferred embodiment of the invention, depositing of the compositions or pre-mixture is accomplished by inkjet printing and particularly by piezoelectric based inkjet printing.

In another preferred embodiment of the invention, depositing of the compositions or pre-mixture is accomplished by extrusion printing.

Inkjet printing may be performed using any of the apparatuses known to a person skilled in the printing field. For instance, in one embodiment, inkjet printing of the compositions according to the invention is performed using one or more printheads, preferably using two printheads, so as to allow simultaneous, semi-simultaneous or subsequent deposition of the liquid compositions onto the same area of the substrate, and one or various consecutive nozzles, for example nozzles 1 to 16 using the disposable cartridges DMC-11610 from Fujifilm Dimatix for the Fujifilm Dimatix DMP-2831/2851 series inkjet printers or the X-Serie printer from Ceradrop.

Based on the specific formulation of the compositions used in the method of the invention, a person skilled in the art will be able to determine the proper settings for carrying out the deposition of such compositions by inkjet printing or by means of any of the other possible printing or coating techniques that are selected. The person skilled in the art will be also able to select the most suitable protocols for the execution of such printing; for instance, in case piezoelectric-based inkjet printing is used as depositing technique, the person skilled in the art will be able to select the proper voltage pulses for piezoelectric actuation, the jetting frequency, the number of active nozzles, the nozzle-to-substrate distance as well as the suitable overlapping distance of adjacent droplets of the printed compositions onto the target substrate and number of printable layers.

In one preferred embodiment of the invention, in step (iii) or (iii′) of the methods according to any of the variants disclosed in the present specification and in the claims, the deposition is accomplished by piezoelectric-based inkjet printing using a jetting frequency ranging between 0.5 and 80 kHz, preferably between 0.5 and 1 kHz, and/or using a nozzle-to-substrate distance between 0.5 to 2 mm, preferably 1 mm.

In one embodiment, during the depositing step, a controlled volume of the fluid compositions according to any of the embodiments disclosed in the present application is dispensed on the substrate. In one preferred embodiment, the dispensed volume is in the range of from about 1-100 μL for a single droplet (exact single droplet volume depends on the used printhead) to about 40 nL/mm²/printed layer-4 μL/mm²/printed layer with 5080 dpi, 1.7 n/mm²/printed layer-168 nL/mm²/printed layer with 1016 dpi, 440 μL/mm²/printed layer-44 nL/mm²/printed layer with 508 dpi and 121 μL/mm²/printed layer-12 nL/mm²/printed layer with 254 dpi.

Preferably, the compositions according to any of the embodiments disclosed in the present application are deposited or dispensed on the substrate by means of a printing or coating technique in the form of adjacent and/or overlapping droplets and/or continuous liquid deposits using a needle or conical plastic tip. Preferably, the dispensed volume in the form of a single droplet covers a substantially circular area with radial dimensions in the range of from about 5 μm to about 5 mm, or preferably from about 200 μm to 5 mm, with different sub-ranges depending on the printing technique used.

Merely by way of example, when a first composition comprising GDA as cross-linking agent is used in the method of the invention, such as any of the liquid compositions disclosed in the present specification and in the claims, the overlapping distance of adjacent droplets of about 20 μL of said composition deposited or dispensed on the target substrate by the selected printing or coating technique is preferably equal to 25 μm. When a second composition comprising BSA as cross-linkable precursor is used in the method of the invention, such as any of the liquid compositions disclosed in the present specification and in the claims, the overlapping distance of adjacent droplets of said composition deposited on the target substrate by means of the selected printing or coating technique is preferably equal to 50 μm for droplet volumes of about 20 μL.

The suitable distance between adjacent droplets of the compositions according to the present invention can be determined by a person skilled in the art based on the droplet size of the same compositions as obtained using the selected printing or coating technique as well as droplet density on the target substrate.

In one alternative embodiment, the compositions according to any of the embodiments disclosed in the present application are deposited or dispensed on the substrate by means of a printing or coating technique so as to form a homogeneous film on the selected substrate, preferably micrometer-thin homogenous films.

In certain aspects, in step (iii) or (iii′) of a method according to any of the embodiments disclosed in the present specification and in the claims, said compositions or pre-mixture are deposited onto the target substrate by providing between about 1 and 100 n/mm² of said compositions or pre-mixture per mm² area onto the substrate.

The specific amounts of materials (i.e., the cross-linking agent, the cross-linkable precursor and one or more active molecules, biomolecules, or enzymes) deposited per area of the target substrate can be calculated based on the droplet sizes (e.g., determined by using the integrated printer droplet analysis cameras and according to picture analysis software) and knowing the droplet density on the target substrate.

According to a preferred embodiment, the method of the invention allows depositing ˜117 (˜234) ng/mm² of GOx, ˜234 (˜468) ng/mm² CAT, ˜914 (˜1828) ng/mm² BSA and ˜137 (˜274) ng/mm² GDA on the target substrate by means of inkjet printing for 1 and 2 (in brackets) inkjet-printed layers.

As mentioned above, in step (iii) of the method of the invention, the deposition of the fluid compositions according to any of the embodiments disclosed herein onto the target substrate is accomplished by means of simultaneous or subsequent deposition using by means of a printing or coating technique such as those exemplified in the present specification and in the claims.

The expression “simultaneous deposition” as employed herein in the context of the invention relates to the fact that said first and second compositions are deposited onto the target substrate at the same time or in parallel, for instance using independent depositing or dispensing means such as independent printheads or nozzles depending on the type of printing or coating technique that is selected.

The expression “subsequent deposition” as employed herein in the context of the invention refers to an execution of multiple depositions sequentially in time. In particular, it refers to the fact that the deposition of said first and second compositions onto the target substrate is carried out by means of a coating or printing technique in separate, i.e., subsequent, time points; in other words, said first and second compositions are deposited onto the target substrate one after the other by means of the selected coating or printing technique.

In one embodiment, in said step (iii), said first composition according to any of the variants disclosed in the present description and in the claims is deposited onto the substrate before said second composition, by means of any of the printing or coating techniques disclosed in the present application and in the claims.

In another embodiment, in said step (iii), said second composition according to any of the variants disclosed in the present description and in the claims is deposited onto the substrate before said first composition, by means of any of the printing or coating techniques disclosed in the present application and in the claims.

Preferably, the time interval occurring between the subsequent depositions of said first and second liquid compositions is less than 1 minute.

In one embodiment, said first and second compositions are deposited onto the target substrate by means of a quasi-parallel deposition wherein the expression “quasi-parallel” refers to the fact that the deposition of said first and second compositions onto the target substrate is carried out subsequently in time within a time frame of ideally 40 msec.

Preferably, in cases when a pre-mixing of the compositions is performed according to step (iii′) of any of the methods disclosed in the present specification, the deposition of the resulting pre-mixture onto the target substrate is performed immediately after the pre-mixing step, wherein immediately is a time frame from 1 (milli) second to less than 10 minutes.

In other words, according to the method of the invention, the pre-mixture of said first and second compositions is deposited onto the substrate before starting of the gelling process, i.e., the formation of cross-links between the cross-linking agent molecules and said one or more molecules or biomolecules (and optionally cross-linkable precursors) that leads to forming the resulting cross-linked matrix. It is hence required that gelling of the compositions according to any of the embodiments disclosed herein to form the resulting cross-linked matrix starts only after said compositions (or, alternatively, their pre-mixture) are deposited onto the target substrate.

Gelling (iv) of the deposited compositions or pre-mixture according to the present invention implies the formation of the cross-linked matrix containing said one or more molecules or biomolecules immobilized therein, i.e., the formation of functional cross-links between the cross-linking agent molecules and one or more active biomolecules.

As will be further explained below, in certain aspects, the method of the invention may advantageously be applied to allow the formation of the active cross-linked matrix onto the target substrate according to a desired pattern. In other aspects, the method of the invention may advantageously be applied to allow the formation of both active and inactive cross-linked matrixes, onto the target substrate, according to a desired pattern. Such approach enables obtaining specific modified substrates or supports possessing or exhibiting spatially controlled properties and functionalities.

A further object of the invention hence specifically refers to a method of forming a cross-linked active matrix onto a substrate according to any of the embodiments disclosed in the present specification and in the claims, further comprising the following steps:
(v) providing a third fluid composition comprising at least one cross-linkable precursor capable of cross-linking with said cross-linking agent in the first composition; wherein said third composition does not comprise any active molecule or biomolecule, and particularly any enzymes capable of catalysing the reduction of oxygen;
(vi) depositing by means of a printing or coating technique a first composition according to any of the embodiment previously disclosed and said third composition on top of each other onto said substrate by means of simultaneous or subsequent deposition; or (vi′) premixing said first and third compositions followed by depositing the resulting pre-mixture onto said substrate; and
(vii) gelling the compositions or pre-mixture deposited in step (vi) or (vi′) so as to obtain a cross-linked inactive matrix onto said substrate, preferably in such a way that said inactive matrix is substantially continuous and/or does not overlap with said cross-linked active matrix onto the substrate.

Depositing of the third composition on the target substrate may be accomplished using any of the techniques known in the art and particularly, any of the printing or coating techniques or protocols previously mentioned in the present specification.

It is preferred that the inactive matrix resulting from the above method depositing a first and a third composition is formed on the target substrate in such a way that does not alter, impede, or suppress the activity of the active matrix that is formed or has to be formed therein. This can be achieved, for example, by properly tuning and programming the deposition design by using any of the digitally controlled printing or coating techniques mentioned in the present specification so as to avoid overlap of the active and inactive matrixes.

The third composition used for the formation or preparation of an inactive matrix according to the above method, may contain a cross-linkable precursor and optionally one or more biocompatible additives, such as specific additives suitable for cell culturing or additives capable of modifying the surface tension or viscosity of the composition, according to any of the embodiments disclosed in the present application and in the claims. Preferably, said third composition is an aqueous composition comprising a defined amount of BSA as cross-linkable precursor, and optionally, a defined amount of Pluronic F-127 and/or Triton X-100.

Depositing of the first, second and/or third compositions according to any of the embodiments of the invention onto the target substrate, can be repeated two or more times so as to obtain the desired thickness of the resulting matrix.

The spatial distribution or formation of the resulting cross-linked active/inactive matrix on the target substrate can vary according to the type of deposition technique that is used in the method of the invention and can be controlled by properly tuning the parameters used for such deposition. Preferably, the spatial distribution or formation of the resulting cross-linked active/inactive matrix on the target substrate obtainable by means of any of the methods disclosed in the present application and in the claims is digitally controlled.

According to a preferred embodiment, in steps (iii), (iii′), (vi) and/or (vi′) of the methods of the invention, depositing is carried out in such a way that a predefined pattern of a cross-linked matrix according to any of the embodiments of the invention is formed onto said substrate, preferably a micro-scale predefined pattern.

Preferably, depositing of the liquid compositions is carried out in such a way that i.) a spatially controlled oxygen gradient, ii.) an oxygen barrier and/or iii.) an oxygen remover/scavenger is generated onto said substrate.

In other words, the cross-linked active matrix resulting from depositing any of the compositions comprising enzymes capable of catalysing the reduction of oxygen, and optionally any cross-linked inactive matrix, as disclosed in the present specification and in the claims, are preferably formed on the target substrate in such a way to obtain a spatially controlled pattern, of said matrixes on the substrate, thereby enabling, in the case of the active material, the formation of spatially controlled oxygen gradients (i.e., locally controlled oxygen densities) on the surface of the substrate.

According to one embodiment, said pattern is predefined based on printing designs and patterns stored on a digitally controlled printing or coating device that is employed in the deposition steps. Suitable printing or coating devices include any instruments or apparatuses known to a person skilled in the art in such field. Patterning design can be realized either with the pattern design software and software tools generally included in the software packages of printers and coaters of the art or by importing pattern designs from files obtained with computer-aided design (CAD) programs, such as Auto-CAD, SolidWorks, Autodesk Inventor, PTC ProE/Creo, CATIA, SpaceClaim or SketchUp.

The predefined pattern is preferably in the form of one or more lines, strips, grids, circles, films, and/or spots. In one preferred embodiment, the deposition of the compositions according to any of the variants disclosed herein is carried out in such a way that parallel strips of the cross-linked active matrix are formed on the target substrate, preferably strips positioned at a distance of at least 0.2, or at least 0.5, or at least 1, or at least 2, or at least 3 or at least 5 mm from each other.

In another embodiment, the deposition of the compositions according to any of the variants disclosed herein is carried out in such a way that parallel, alternating strips of the cross-linked active and inactive matrix are formed on the target substrate, preferably such alternating strips are formed in such a way that a grid-like pattern of active/inactive matrix strips is generated on the target substrate.

In another embodiment, the deposition of the compositions according to any of the variants disclosed herein is carried out in such a way that a homogeneous film of the cross-linked active matrix is formed on the target substrate, preferably a micrometre-thin homogeneous film. A person skilled in the art will be able to select the most suitable compositions among those disclosed in the present specification, as well as a proper depositing technique and settings in order to obtain an active matrix in the form of a film possessing the desired thickness and physical-chemical properties.

Alternatively, homogeneous layers of the active/inactive matrix with controlled thicknesses and thus oxygen reduction activity can be fabricated using the printing/dispensing/coating techniques listed and described in this specification to create oxygen blocking and oxygen removal layers.

According to a preferred aspect, in step (iii), (iii′), (vi) and/or (vi′) of any of the above methods, depositing is performed between 2 and 40° C., preferably at room temperature.

The method according to any of the embodiments disclosed in the present specification and in the claims may further include a step of subjecting said cross-linked matrix to one or more washing steps. Such step is useful to allow removal of excess non-cross-linked compounds from the formed matrix and/or substrate' surface.

Any of the methods of the invention may further comprise a step of measuring the oxygen gradient generated by deposition of said active/inactive matrix onto the substrate. In particular, said measuring is performed by means of a scanning electrochemical microscope.

Active or Inactive Matrixes Formed onto the Selected Substrate

According to a preferred embodiment, the resulting active/inactive matrix that is formed with any of the methods disclosed in the present specification or in the claims is in the form of hydrogel, such as silicone hydrogels, polyacrylamides, polyacrylamide derivatives, cellulose, cellulose derivatives, collagen, carboxymethylcellulose, alginate, chitosan, agar, polimacon, hyaluronic acid, polymethylmethacrylate, polymethylmethacrylate derivatives, hydrogel peptide-mimetics could be used, wherein the enzymes are associated to the matrix with crosslinking agents or mechanically trapped after/during the matrix crosslinking. Preferably, the resulting cross-linked active matrix is optically transparent in the visible region of the electromagnetic spectrum (i.e., 350-700 nm).

Anywhere in the present specification and in the claims the term “cross-linked active/inactive matrix” may be replaced by the term “cross-linked active/inactive hydrogel”.

In one aspect, considering 2D printing, the cross-linked active or inactive matrix according to any of the embodiments disclosed in the present specification and in the claims, has a thickness in the nanometre or micrometre range, preferably has an average thickness comprised between 50 nm and 5 μm, even more preferably between 100 to 250 nm, an average thickness equal to about 120 nm or 250 nm. Considering 3D printing, the cross-linked active or inactive matrix according to any of the embodiments disclosed in the present specification and in the claims, has a thickness in the micrometre or millimetre range, preferably has an average thickness comprised between 100 μm and 1 mm, even more preferably between 0.3 to 0.6 mm, an average thickness equal to about 0.3 mm or 0.5 mm.

In another aspect, the cross-linked active matrix comprises one or more enzymes capable of catalysing the reduction of oxygen according to any of the embodiments disclosed herein. Micro-structured patterns of homogeneous enzymatic activity create three-dimensional oxygen diffusion profiles in the environment surrounding the microstructures while enzymes homogeneously distributed in thin films result in semi-infinite linear diffusion profiles.

It is preferred that the resulting active and/or inactive matrix formed on the selected substrate according to any of the methods disclosed in the present specification and in the claims is suitable for cell culturing, particularly for culturing mammalian cells such as human cells.

According to a preferred embodiment of the invention the resulting active and/or inactive matrix formed on the selected substrate according to any of the methods disclosed in the present specification and in the claims, preferably in the form of a homogeneous film, is suitable for packaging applications, preferably packaging of drugs, food and/or beverages. In another embodiment an active matrix formed on the selected substrate according to any of the methods disclosed in the present specification and in the claims is suitable for sensing, preferably is used for signal transduction in sensor applications.

It hence forms part of the present invention also a method for the fabrication or preparation of a film or layer of an active cross-linked matrix according to any of the variants disclosed in the present specification onto a target substrate, or else between two target substrates according to any of the embodiments disclosed herein, for packaging applications, preferably packaging of drugs, food and/or beverages. Preferably, said film or layer is homogeneous. Said fabrication or preparation may comprise performing the steps of a method according to any of the embodiments disclosed in the present specification and in the claims.

A further object of the invention is represented by a method for fabricating a sensor, particularly an electrochemical or optical biosensor, such as a fluorescence biosensor, comprising forming a cross-linked active matrix onto a substrate with one or more working electrodes by means of a method according to any of the embodiments disclosed in the present specification and in the claims.

### Substrates

Non limiting examples of substrates or supports that can be used in any of the methods of the present invention include glass, such as glass slides, as well as metal, cardboard, paper, ceramic, cloth, leather, fiber, wood, plastics, bioplastic and polymeric materials or combinations thereof.

Suitable polymeric materials may be any substrate known in the art and may include, for example, polyacrylates, polymethylacrylates, polycarbonates, polystyrenes, polysulphones, polyhydroxy acids, polyanhydrides, polyorthoesters, polypropylenes, polyphosphazenes, polyphosphates, polyesters, cyclic polyolefin copolymers, derivatives thereof or mixtures thereof, which may be surface-modified (for example plasma treated) or untreated.

In one embodiment, the selected substrate is any substrate known in the art that might be used for packaging, in particular packaging of drugs, food and beverages.

It is preferred that the selected substrate is optically transparent in the visible region of the electromagnetic spectrum (350-700 nm). The substrate can also be a biomaterial foil, bioplastic foil or organic layers, i.e., substrates that may not be fully transparent in the visible region.

In one embodiment, the selected substrate is particularly a substrate or support suitable for cell culture applications, such as a microscopy glass slide, microscopy plastic slide, a Petri dish, multiple well plates, microwell plates, slides, flasks, cell stack, multi-layer cell culture articles or any other container/support known in the art to be suitable for cell culturing.

In one embodiment, the selected substrate is any substrate known in the art that might be used for sensing applications, e.g., electrochemical or optical sensing applications, particularly a plastic substrate, a glass substrate or a ceramic substrate containing at least one, two, three or a plurality of electrodes, as will be further illustrated below. Preferably, such substrate suitable for sensing applications is a flexible substrate.

A further object of the present invention is represented by a substrate, in particular a substrate for in vitro cell culturing obtainable by a method according to any one of the embodiments disclosed in the present specification and in the claims.

In one embodiment, the substrate is a substrate suitable for cell culture, e.g., a Petri dish or a multiple well plate, whose upper face has a cross-linked active matrix formed thereto, which matrix specifically comprises enzymes capable of catalyzing the reduction of oxygen according to any of the embodiments disclosed in the present application. Notably, said active matrix is formed on the upper face of the substrate according to a predefined pattern, thereby resulting in the generation of a spatially controlled oxygen gradient.

In one preferred embodiment, the substrate is a substrate suitable for cell culture, e.g., a Petri dish, whose upper face has alternating, parallel strips of a cross-linked active and optionally inactive matrix formed thereto according to any of the variants disclosed in the present specification and in the claims, thereby resulting in the generation of a spatially controlled oxygen gradient. The formation of a functional material comprising one or more enzymes capable of catalyzing the reduction of oxygen onto a substrate according to any of the methods disclosed in the present specification and in the claims, may be used to control the chemical microenvironment of a cell culture and/or mimicking physiological or pathological conditions of the in vivo cells. Different cell lines or primary cells may hence be cultured onto a suitable substrate for cell culture according to any of the embodiments disclosed herein. In one other preferred embodiment, the substrate is a substrate suitable for packaging of food and beverages, whose face is covered with a layer or film of a cross-linked active matrix formed thereto according to any of the variants disclosed in the present specification and in the claims, thereby resulting in the generation of an oxygen blocking and oxygen removal layer. The formed matrix can be also used to glue together two substrates suitable for packaging, in this case the matrix according to any of the variants disclosed in the present specification will be sandwiched between two substrates.

In one other preferred embodiment, the substrate is an electrochemical sensor, for example screen-printed or inkjet printed on a flexible plastic substrate, on a glass substrate or on a ceramic substrate, that contains one, two or three electrodes, of which one is always a working electrode, made of a conductive or semiconductive material, such as gold, platinum, or made of a carbonaceous material, such as graphene or carbon nanotubes, or any other solid electrode material, stable in the potential region applied and solution matrix used, optionally modified with catalytically active nanoparticles, such as Prussian Blue or platinum black, of which the second electrode is a reference electrode or joint reference/counter electrode, preferably made of or coated with silver or silver chloride, and of which the third electrode is a counter electrode, made of graphite, graphene, carbon nanotubes, platinum or gold. In case the sensor contains only one or two electrodes, the other two or one electrode(s) can be added as external electrodes.

According to one aspect of the invention, an active material according to any of the variants disclosed herein is printed on the entire sensor surface or alternatively just on the working electrode surface of any of the electrochemical sensor substrates listed above by using a method according to any of the embodiments disclosed in the present specification and in the claims, thereby forming, in both cases, an electrochemical biosensor.

In one preferred embodiment, said active material comprises at least one enzyme that is capable of catalyzing the reduction of oxygen with simultaneous oxidation of an analyte of interest, thereby enabling the quantitative, qualitative and selective detection of the analyte.

In one preferred embodiment, the active material printed on the sensor surface contains GOx and BSA. Preferably, the active material does not contain glucose. In such configuration, the electrochemical biosensor obtained by printing the active material containing GOx and BSA onto a suitable substrate as illustrated above may be used for sensing glucose. In other terms, glucose is the analyte that is detectable by the electrochemical biosensor, called glucose sensor.

Merely by way of example, a liquid droplet, containing glucose and a supporting electrode, i.e., a salt dissociated in water with a concentration of e.g., 100 mM, or a buffer of 100 mM ionic strength with physiological pH, e.g., 7.4, is deposited on the sensor. Glucose is then enzymatically oxidized in the active material generating gluconolactone and hydrogen peroxide. Hydrogen peroxide is then electrochemically reduced or oxidized at the working electrode, depending on the selected potential of the working electrode versus the reference electrode. The recorded current is proportional to the analyte concentration. Doing a calibration measurement, the electrochemical biosensor can be used for medical glucose sensing. The way of printing the active matrix is the innovative step.

According to another aspect of the invention, the substrate is an electrochemical or optical sensor, for example screen-printed or inkjet printed on a flexible plastic substrate, on a glass substrate or on a ceramic substrate, that contains more than one working electrode, preferably a plurality of working electrodes. In a certain aspect of the invention, a plurality of active matrixes or materials according to any of the variants disclosed herein, each comprising a different combination of active molecules or biomolecules according to any of the embodiment disclosed in the present specification, are printed on the surface of said plurality of working electrodes by using a method according to any of the embodiments disclosed in the present specification, thereby forming an electrochemical or optical biosensor suitable for multi-analyte detection.

According to another embodiment of the invention, a functional material according to any of the embodiments disclosed in the present specification can be placed between two distinct substrates, i.e., being sandwiched between two substrates (e.g., plastic foils, biomaterial foils, paper sheets or glass slides).

### Kits

One aspect of the invention is particularly referred to a kit comprising a first fluid composition comprising at least one cross-linking agent and a second fluid composition comprising one or more molecules or biomolecules according to any of the embodiments disclosed in the present specification and in the claims; and wherein said one or more molecules or biomolecules are capable of cross-linking or being cross-linked with said cross-linking agent. Preferably, said second composition further comprises at least one cross-linkable precursor according to any of the embodiments disclosed in the present specification and in the claims.

Such kit may further include a third fluid composition according to any of the embodiments that are disclosed in the present detailed description and in the claims.

The kit according to the invention disclosed herein may further comprise one or more substrates, and particularly a substrate or support suitable for cell culturing according to any of the embodiments disclosed in the present specification and in the claims or a substrate or support suitable for packaging of drugs, food and/or beverages, or else suitable for sensing, e.g., electrochemical sensing.

A further object of the invention refers to the use of a kit according to any of the embodiments disclosed herein for the fabrication or preparation of a cross-linked active and optionally inactive matrix for in vitro cell culturing onto a target substrate. In one embodiment, such fabrication or preparation is specifically carried out by any of the methods or using any of the compositions disclosed in the present specification and in the claims.

A further object of the invention refers to the use of a kit according to any of the embodiments disclosed herein for the fabrication or preparation of a homogeneous film of an active layer onto a target substrate, or else between two target substrates according to any of the embodiments disclosed herein, for packaging of drugs, food and/or beverages. In one embodiment, such fabrication or preparation is specifically carried out by any of the methods or using any of the compositions disclosed in the present specification and in the claims.

A further object of the invention refers to the use of a kit according to any of the embodiments disclosed herein for the fabrication or preparation of a sensor, in particular an electrochemical sensor, comprising forming a cross-linked active matrix onto a target substrate. Such fabrication or preparation is specifically carried out by means of a method according to any of the embodiments disclosed in the present specification and in the claims.

Examples are reported below which have the purpose of better illustrating the methodologies disclosed in the present description, such examples are in no way to be considered as a limitation of the previous description and the subsequent claims.

### EXAMPLES

### Example 1—Preparation of Ink Formulations for Inkjet Printing of 2D Functional Layers and Patterns Containing and not Containing Entrapped Active Molecules

### Introduction

Herein, the microfabrication of cell culturing microenvironments with steady-state oxygen gradients similar to those found in vivo is presented using inkjet printing. This digital printing technique has been applied to print on cell culturing supports, such as glass slides and other flat solid substrates, 2D protein-based hydrogels (hereinafter also indicated as “active materials”), formulated using proper amounts of inert proteins and glucose oxidase/catalase systems for oxygen regulation. Inks and pattern designing were developed to create controllable oxygen gradients on demand in the dishes.

### The Active Material

The tested active material is based on a cross-linked protein-hydrogel, which includes enzymes able to control the concentration of the physiological and pathological soluble components. Thanks to chemical reactions they catalyze the reaction of such components and at the same time remove toxic by-products produced by the process. The gelling relies on covalent binding of two (or more) molecules by a cross-linker. Enzymes present a variety of functional groups that can be readily bound and linked by a number of agents. The amino groups, which are present at the N-terminal end and at lysine residues, and the carboxylic groups, present at the C-terminal end and at glutamic and aspartic acid residues, are employed in the crosslinking.

Immobilization by covalent linking using glutaraldehyde (GDA) is a friendly procedure requiring mild conditions that include aqueous buffer solution and physiological pH, ionic strength, and temperature. Glutaraldehyde readily links the amine groups of proteins and enzymes causing the formation of the protein-hydrogel (FIG. 1). Bovine serum albumin (BSA) is used as inert protein to build the bulk material of the hydrogel. The active proteins/enzymes required for the material functionality can be added based on predefined ratios. These active moieties can be added in a large range of concentrations allowing for a fine-tuning of their function, which is to shape the chemical microenvironment.

The enzymes that make the tested hydrogel active in the chemical environment are Glucose Oxidase (GOx) and Catalase (CAT) that catalyse the following reactions:

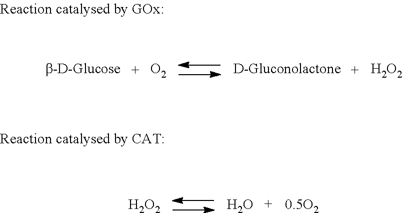

Locally immobilized GOx controls the local levels of dissolved molecular oxygen by the continuous, but local consumption of oxygen. The difference in local oxygen concentration near the active material and in the bulk generates oxygen gradients by diffusion. The spatial addressing of such function establishes designer's gradients. The substrate of the enzymatic reaction with GOx is glucose, which is constitutionally present in almost all cell culture media (normal glucose concentrations range from 5 mM to 25 mM). The by-product of the glucose oxidation is hydrogen peroxide, which at high concentrations is toxic for living cells while it triggers cell responses at low concentrations. For this reason, the hydrogel material has been supplemented with interlinked catalase moieties, CAT, in order to scavenge hydrogen peroxide directly in the active material and to exclude the possibility of cell exposition to this agent in the surrounding of the active material where cells grow.

As a result, the formulated hydrogel offers two different functions: i) it regulates the local oxygen contents and spatial generation of oxygen concentration gradients; ii) it scavenges a cell toxic by-product generated by the material function itself.

### The Printing Strategy

The spatial patterning of the active material is crucial to address and determine, at the microscopic level, the quantities of oxygen of the microenvironment. The concentration of the enzymes in the active material and the hydrogel distribution on the bottom plates in culturing dishes can be controlled by the composition of inks and the parameters used for digital printing. This enables programming and tuning of the in vivo mimetic conditions.

In the present study, inks have been developed that contain the gel precursor components and that can be applied to generate highly resolved designs of the cross-linked hydrogel by utilizing two optimised digital patterning strategies, i.e., 2D inkjet printing (FIG. 2a) and extrusion 3D bioprinting (FIG. 2d). Both techniques were able to accurately print patterns, such as lines or grids, as it can be seen in FIGS. 2b and e, respectively. The inkjet concept is based on the sequential printing of a “protein ink” (GOx, CAT and BSA, second liquid composition) and a “cross-linker ink” (GDA, first liquid composition). Piezoelectric-based inkjet printing with two parallel printheads and ink reservoirs (FIG. 3) was employed to mix the two inks directly on the substrate surface where they reacted immediately to form the hydrogel (FIG. 2a). Key advantages of the inkjet concept are the digital control of all printing parameters, e.g., the number and volume of droplets (i.e., the exact amount of the materials per area), and the ability to store and print the two inks (inactive when not in contact) over extended periods (we printed hydrogels even after more than twelve months of ink storage at 4° C.). The inkjet printing process resulted in (sub) micrometer thin, thus two-dimensional, films as confirmed by the laser-based optical analysis (FIG. 2c). Due to the well-known coffee-ring effect (see below), the borders of 100 μm wide lines were slightly higher than in the centre, which, however, did not affect the oxygen gradient formation by diffusion.

Piezoelectric inkjet printing requires the precise control of physico-chemical fluid properties. Therefore, both inkjet inks contained on the one hand a minor amount of the Triton X-100 surfactant to adjust the surface tension. On the other hand, the “cross-linker ink” contained Pluronic F-127, a biocompatible poloxamer, to increase the ink viscosity. The “protein ink”, however, was slightly pre-cross-linked by the addition of a small amount of GDA to increase the ink viscosity by a minor polymerization. The non-reactive ink stabilizing agents were removed from the cross-linked hydrogel by immersion into DI-water. This is an optional step and not necessarily required for all applications.

### Materials and Methods

### Materials for Ink Formulation

β-D-Glucose BioXtra ≥99.5%, glucose oxidase (GOx) Type X-S from Aspergillus niger (100-250 U/mg), glutaric dialdehyde (glutaraldehyde, GDA) as 25 wt. % solution in water, Pluronic F-127 and Triton X-100 were purchased from Sigma-Aldrich. Bovine serum albumin (BSA) was from ID Bio, PBS (pH 7.4) from Lonza and deionized (DI) water was produced with a Milli-Q plus 186 from Millipore. The enzymes and BSA were added to PBS (pH 7.4).

### Inkjet Printing of GDA and Protein Inks

The surface tension and viscosity of the inks were determined using a Drop Shape Analyzer DSA30S (Krüss) and a Viscometer SV-1A (A&D), respectively. The morphology of inkjet-printed hydrogel patterns was analysed using a Keyence VK 8700 laser-scanning microscope (LSM).

### Inkjet Ink Formulation

For inkjet printing two bio-inks were formulated, i.e. a cross-linker ink and a protein ink.
The cross-linker ink contained 10 μL/mL GDA (25 wt. % in water), 25 mg/mL Pluronic F-127 and 0.375 μL/mL Triton X-100. First Pluronic F-127 was dissolved in DI water reaching a viscosity of 1.3 mPa·s, which was followed by the addition of GDA and Triton X-100, from which the latter lowered the surface tension of the ink to ˜30 mN/m.
The protein ink was composed of 31.25 mg/mL BSA, 4 mg/mL GOx, 8 mg/mL CAT and 1 μL/mL GDA (25 wt. % in water). After mixing BSA, GOx and CAT in PBS, the addition of a defined low amount of GDA resulted in a controlled limited cross-linking of a small portion of the gel precursor in order to increase the ink viscosity to ˜1.2 mPa·s but not to polymerize the ink until hydrogel. Thereafter, 0.375 L/mL Triton X-100 was added to lower the surface tension of the aqueous ink to ˜30 mN/m.

The ink characteristics were stable for several months.

### Inkjet Printing of Hydrogels

Cross-linked hydrogel patterns were generated by using an X-Serie Ceraprinter (Ceradrop) that can be equipped with up to three parallel printheads for printing up to three different liquid compositions. The gel precursor inks were subsequently printed using two Fujifilm Dimatix cartridges DMC-11610, which contain 16 individually addressable nozzles of around 21.5 μm orifice diameter. The droplet ejection is based on piezoelectric actuation used for drop-on-demand operation. For both inkjet inks, various printing parameters were optimised, such as the voltage pulses for the piezoelectric actuation, jetting frequency, number of active nozzles, overlapping of adjacent droplets on the substrates and number of printed layers. The nozzle-to-substrate distance was 1 mm. All inkjet printing processes were carried out at room temperature. Microscope glass slides were used as substrates.

First, the cross-linker ink (first liquid composition) was printed and directly after the protein ink (second liquid composition containing active biomolecules). Before using, the as-printed hydrogels were washed gently with PBS. The droplet volume was calculated from droplet images taken with the drop analyzer CCD camera (1392×1040 pixels) incorporated into the Ceraprinter and processed with ImageJ 1.50i software (W. Rasband, National Institutes of Health, USA). The droplet size of the cross-linker and protein inks was 21.0 μL and 21.6 μL, respectively. The amount of materials inkjet printed per area were calculated by using these droplet sizes and knowing the droplet density on the substrate.

### Height Profiles of the Printed Hydrogels

Height profiles of inkjet printed hydrogel bands were recorded with the LSM after washing with DI water. The image focus was made on one printed band that was generated by three consecutive nozzles in one and two printing passes for each ink. 1 IJPL cross-linker ink and 1 IJPL protein ink after washing resulted in a hydrogel pattern with a general thickness of ˜120 nm (FIG. 2c). The higher parts on the border of the printed lines are a result of the well-known coffee ring phenomenon where solid material accumulates at the substrate-liquid-air interface during drying of the printed bands. The height in this confined region can reach 850 nm. Printing the double amount of material enhances the thickness of the center of the printed bands to a height of ˜250 nm. However, it can be expected that the enzyme activity is equally distributed in the gel causing an overlap of the diffusion layers of oxygen and creating a homogeneous diffusion profile for each gel band, even with higher borders. This effect makes the observed height differences on the micrometer scale negligible for the gel functionality.

### Scanning Electrochemical Microscopy

SECM measurements were performed using an experimental setup coupling a 910B SECM (CH Instruments) with a Nikon Ti inverted optical microscope. The stepper motors and the piezoelectric component of the 910B CHI instrument for the microelectrode displacement were removed from the original stage and mounted on the plate of the inverted microscope. The apparatus modifications for the optical/electrochemical microscope coupling were accomplished in house (S. Rapino et al. Chem. Commun. 2014, 50, 13117; I. Ruggeri et al. J. Phys. Chem. Lett. 2019, 10, 3333). All electrochemical measurements were carried out in Petri dishes located on the plate holder of the inverted microscope. The SECM probe was a 10 μm Pt diameter ultra-microelectrode (UME) with a ratio of the glass sheath and the active electrode radius, RG=10. The tip was polished and cleaned prior the use with polishing clothes with alumina (0.05 μm) followed by sonication for some seconds in a bath sonicator. A platinum wire was used as the counter electrode and all the potentials are referred to the (Ag/AgCl/3M KCl) reference electrode. The dissolved oxygen was used as redox mediator, and the UME was positioned over the plastic dish at a controlled tip/Petri dish surface (more in general, cell culturing surface) distance by employing approach curves with an electrode potential E_{UME}=−0.7 V and following the negative feedback resulting by the Petri surface diffusion hindrance. SECM images were accomplished at a tip/active material distance of about 10 μm. The translational rate of the UME for the SECM images was 20 μm/s.

### Functional Characterisation of the Fabricated Spatial Gradients

Scanning ElectroChemical Microscopy (SECM) is an analytical tool that is unique for the measurement of local concentrations, concentration gradients and fluxes. It can locally map the concentrations of fundamental metabolites. It uses micro-positioners to bring an ultra-microelectrode (UME) in close proximity to a substrate and to translate it over a sample area of interest. Information about the local activity of a sample can be obtained. For instance, SECM was used to measure heterogeneous electron transfer kinetics of reactions taking place at the solution/substrate interfaces, for the rapid screening of electro- and photocatalysts and for the investigation of biological systems, which includes enzymes and living cells. SECM is particularly suitable for metabolic analyses at single cell level, thanks to its micrometric resolution.

Micrometric functional SECM imaging of the local oxygen concentration gradients generated by the hydrogel in the cell culturing environments (FIG. 4a) was performed. We measured i) the oxygen concentration gradients in the liquid media along a direction normal to the centre of a deposited functional material strip (vertical oxygen profile, “vertical scan”), and ii) the oxygen concentration and oxygen gradients along the xy-plane at a fixed distance from the bottom of the Petri dish—or more in general from the cell culturing surface-(horizontal oxygen profile, “horizontal scan” and “imaging”).

The SECM analysis is based on the electrochemical reduction of oxygen at the Pt-based UME, which is directly related to its concentration. The oxygen concentration (expressed as oxygen partial pressure pO₂) was measured starting from 800 μm in a direction normal to the hydrogel surface and approaching the hydrogel vertically until zero distance. Indeed, the pO₂ decreased from ˜10% to 0% due to the active consumption of oxygen by the hydrogel (FIG. 4b, blue curve). We performed the same measurement on the control material (i.e., protein hydrogel without the enzymes) and observed a constant oxygen concentration of 21% pO₂ until the UME reached the very close proximity of the control surface (FIG. 4b, black curve). The sudden decrease of the recorded current (i.e., pO₂) in that particular region is only due to the well-known negative feedback caused by the hindrance of the oxygen diffusion by the nearby plastic surface. We investigated the lateral oxygen concentration levels by translating the UME in constant height mode (˜12 μm above the bottom of the Petri dish) perpendicularly over various hydrogel bands. The oxygen concentrations ranged in all cases between 0% and 21%. For instance, patterned lines distant 1.7 mm yield oxygen percentages ranging from 0% to 6% over 0.85 mm, patterned lines distant 2.0 mm yield oxygen percentages ranging from 0% to 9% over 1 mm, patterned lines distant 2.5 mm yield oxygen percentages ranging from 0% to 12% over 1.25 mm (FIG. 4c). The oxygen content imaged in a region of 300′0000 μm² comprising a hydrogel strip pattern in the centre of the imaged frame showed 02 levels ranging from 0% to 10% pO₂ (FIG. 4d). Notably, in this specific device architecture the material recreates the gradients present in living tissues between the blood vessels and in the necrotic cores of cancer tumours.

These results show that the spatially resolved architecture of the hydrogel patterns generates a stable oxygen microenvironment. The method can therefore be used to reproduce accurately the oxygen concentrations that exist in in vivo niches. It can be programmed and designed in accordance with the targeted in vivo situations found in real human tissues, both in terms of absolute oxygen concentrations and of the steepness of the concentration gradient.

### Example 2—Preparation of Ink Formulations for Extrusion Printing of 3D Functional Layers and Patterns Containing and not Containing Entrapped Active Molecules

### Introduction

Herein, the microfabrication of cell culturing microenvironments with steady-state oxygen gradients similar to those found in vivo is presented using extrusion printing. This digital printing technique has been applied to print inside Petri dishes 3D protein-based hydrogels (hereinafter also indicated as “active materials”), formulated using proper amounts of inert proteins and glucose oxidase/catalase systems for oxygen regulation. Inks and pattern designing were developed to create controllable oxygen gradients on demand in the dishes. The thickness is controllable by the amount of ink printed per area and can be in the range of micrometers up to millimeters.

### The Active Material

See details in Example 1.

### The Printing Strategy:

The extrusion printing concept is based on the use of a dispensing needle (FIG. 2d), preferably blunt needles of 25G with a blunt length of 43 mm. Two viscoelastic fluid compositions, achieved by adding substantial amounts of Pluronic F-127 and heating to 37° C., enabled stable extrusion/dispensing and slowed down the cross-linking rate of the components compared to solutions. The two viscoelastic fluids were then pre-mixed inside the dispensing tip and immediately printed. Cross-linking occurred therefore only after the deposition of the premixed components on the substrate.

### Materials and Methods

### Materials for Ink Formulation

β-D-Glucose BioXtra ≥99.5%, glucose oxidase (GOx) Type X-S from Aspergillus niger (100-250 U/mg), glutaric dialdehyde (glutaraldehyde, GDA) as 25 wt. % solution in water, Pluronic F-127 was purchased from Sigma-Aldrich. Bovine serum albumin (BSA) was from ID Bio, PBS (pH 7.4) from Lonza and deionized (DI) water was produced with a Milli-Q plus 186 from Millipore. The enzymes and BSA were added to PBS (pH 7.4).

### Extrusion 3D Printing

Extrusion 3D printing was carried out with a Cellink Inkredible+3D-Bioprinter.

### a) 3D Active Matrix Extrusion Printing:

The active ink, i.e., the ink to print the active hydrogel, was prepared by pre-mixing in a 1:1 ratio two viscoelastic fluids, which were both prepared by first adding 25% w/v Pluronic F-127 in PBS generating a Pluronic F-127 solution and then gelating it by heating to 37° C. To the first viscoelastic fluid 2.8% v/v GDA (25 wt. % aqueous solution) was added. To the second viscoelastic fluid 128 mg/L BSA, 16 mg/L GOx and 32 mg/L CAT were added. The pre-mixed active ink was therefore composed of 64 mg/ml of BSA, 8 mg/mL GOx, 16 mg/mL CAT and 1.4% v/v GDA (added as 25 wt. % aqueous solution) and 25% w/v Pluronic F-127 and immediately printed after pre-mixing to cross-link the two viscoelastic fluids to the active hydrogel The extrusion pressure was 135 kPa at 22° C. (FIG. 2e).

### b) 3D Inactive Matrix (Control) Extrusion Printing:

The control ink, i.e., the ink to print the control hydrogel, was prepared by mixing in a 1:1 ratio two viscoelastic fluids, which were both prepared by first adding 25% w/v Pluronic F-127 in PBS generating a Pluronic F-127 solution and then gelating by heating to 37° C. To the first viscoelastic fluid 2.8% v/v GDA (25 wt. % aqueous solution) was added. To the second viscoelastic fluid 128 mg/L BSA were added. The pre-mixed control ink was therefore composed of 64 mg/mL of BSA and 1.4% v/v GDA (added as 25 wt. % aqueous solution) and 25% w/v Pluronic F-127 and immediately printed after pre-mixing to cross-link the two viscoelastic fluids to the control hydrogel. The extrusion pressure was 160 kPa at 22° C. (FIG. 2e).

### Example 3—Preparation of Ink Formulations for the Fabrication of Polymeric Layers Containing Entrapped Active Molecules Such as Enzymes for Glucose Biosensing

### Introduction

Herein, the microfabrication of a hydrogel containing GOx for amperometric glucose sensing is presented. A digital printing technique is applied to modify the working electrode of a three-electrode sensor with active hydrogels that contain proteins and GOx. This assembly is exemplarily used for electrochemical glucose detection through the enzymatic oxidation of the enzymatic substrate glucose at GOx in presence of oxygen. Oxygen acts as co-substrate and electron acceptor. Inks and pattern designing were optimized to obtain the local enzymatic reaction with rapid quantitative electrochemical response to the presence of glucose. The concept of electrochemical glucose sensing adapted in this step is known, but the procedure of printing the active material is novel.

### The Active Material

The active material is the same as the one in Example 2, with the only exception that it does not contain CAT. CAT transforms H₂O₂, which in high concentrations is harmful for living cells and food, into H₂O. For electrochemical sensing however, the presence of H₂O₂ is beneficial, because H₂O₂ is the most electro-active component of the system and is used for the electrochemical quantification of glucose through the electrochemical reduction of H₂O₂ at the sensor surface that is covered with the active material. Glucose as enzymatic substrate and oxygen as co-reactant generate stoichiometrically hydrogen peroxide.

### The Printing Strategy

The surface of a screen-printed DropSens 250AT electrode (Metrohm), containing a gold working electrode, a platinum counter electrode, and a silver reference electrode, was modified by depositing via extrusion 3D printing directly on the sensor a volume of few microliters of a pre-mixed viscoelastic fluid composition, prepared by mixing two viscoelastic fluid compositions, one with cross-linking agent GDA and Pluronic F-127 and the other one with cross-linker BSA, GOx and Pluronic F-127.

### Materials and Methods

Glucose oxidase (GOx) Type X-S from Aspergillus niger (100-250 U/mg), glutaric dialdehyde (glutaraldehyde, GDA) as 25 wt. % solution in water were purchased from Sigma Aldrich; PBS sterile solution was purchased from ThermoFisher; Pluronic F-127 was purchased from Sigma Aldrich.

Glucose oxidase (GOx) was added to PBS reaching a final concentration of 8 mg/mL in the premixed viscoelastic fluid; GDA was added to reach a final concentration of 0.35% v/v in the premixed viscoelastic fluid.

### Extrusion 3D Printing

Extrusion 3D printing of the pre-mixed viscoelastic fluid composition (5 μL) was performed with a Cellink Inkredible+3D-Bioprinter following the strategy in Example 2. The extrusion pressure was 135 KPa at room temperature; blunt needles of 25G with a length of 43 mm were employed.

### Electroanalytical Glucose Detection

Electrochemical glucose detection for the creation of a glucose calibration graph was carried out by dropping 45 μL of PBS solution onto the screen-printed 250AT electrode that had previously been modified with the active material containing GOx, but no CAT. Then the chronoamperometric (CA) detection of glucose was started by biasing the working electrode at +0.65 V versus the reference electrode. This electrode potential was suitable to oxidize H₂O₂ that was enzymatically generated at GOx when glucose was thereafter stepwise added to the test solution. A DropSens portable STAT-I 400 was employed for the chronoamperometric measurement.

As shown in FIG. 5c-left, the background current, i.e., the current caused by events different than glucose detection and subtracted from the analytical signal, stabilized in the PBS solution without glucose at approximately 260 seconds. Thereafter, defined volumes of a 2 mM glucose stock solution were added to increase iteratively the glucose concentration in the test solution to 200 UM, 382 μM, 549 μM and 835 μM. GOx catalyzed the oxidation of glucose to gluconolactone by using oxygen as co-reactant (electron acceptor) and thus producing hydrogen peroxide in a 1:1 molar ratio with respect to glucose consumption. Stoichiometric production of hydrogen peroxide with respect to glucose oxidation is key for the electrochemical detection described herein. By extracting the averaged plateau currents of the CA after each addition of glucose a calibration graph was created by linear regression. The average plateau current was plotted versus glucose concentration (FIG. 5c-right) resulting in a linear calibration line with R²=0.9999. From the calibration graph, the sensitivity (i.e., the slope) and the limit of detection (LOD) were determined as 140 pA/μM and 11 μM, respectively.

1. A method of forming a cross-linked active matrix onto a substrate, comprising the following steps:
(i) providing a first fluid composition comprising at least one cross-linking agent;
(ii) providing a second fluid composition comprising one or more active molecules or biomolecules capable of cross-linking with said cross-linking agent;
(iii) depositing by means of a printing or coating technique the first and second compositions on top of each other onto said substrate by means of simultaneous or subsequent deposition; or (iii′) premixing said first and second compositions followed by depositing the resulting pre-mixture onto said substrate; and
(iv) gelling the compositions or pre-mixture deposited in step (iii) or (iii′) so as to obtain said cross-linked active matrix onto the substrate.

2-6. (canceled)

7. The method of claim 1, wherein said second composition further comprises the enzyme catalase (CAT).

8-9. (canceled)

10. The method of claim 1, wherein said first and/or said second composition further comprise at least one biocompatible additive selected from additives capable of modifying the viscosity and/or surface tension of the composition.

11. The method of claim 10, wherein said at least one additive is selected from Pluronic F-127 and Triton X-100.

12. The method of claim 1, wherein said first composition is an aqueous composition comprising GDA and Pluronic F-127.

13. The method according to claim 12, wherein, in said first composition, GDA is present in an amount ranging from 1 to 40 μL/mL of a 25 wt. % GDA solution in water, and Pluronic F-127 is present in an amount ranging from 5 to 300 mg/mL.

14. The method of claim 12, wherein, said first composition comprises GDA in an amount equal to 10 μL/mL, Pluronic F-127 in an amount equal to 25 mg/mL, and Triton X-100 in an amount ranging from 0.09 to 0.5 L/mL, and wherein in said step (iii) or (iii′) the depositing is accomplished by inkjet printing.

15. The method of claim 12, wherein said first composition comprises GDA in an amount equal to 28 μL/mL of a 25 wt. % GDA solution in water and Pluronic F-127 in an amount equal to 250 mg/mL, and wherein in said step (iii) or (iii′) the depositing is accomplished by extrusion printing.

16. The method of claim 1, wherein said second composition is an aqueous composition comprising BSA, GOx, and CAT.

17. The method according to claim 16, wherein BSA is present in an amount ranging from 15 to 250 mg/mL, GOx is present in an amount ranging from 2 to 32 mg/mL, and CAT is present in an amount ranging from 4 to 64 mg/mL.

18. The method of claim 16, wherein; said second composition comprises BSA in an amount equal to 31.25 mg/mL, GOx in an amount equal to 4 mg/mL, CAT in an amount equal to 8 mg/mL, and Triton X-100 in an amount ranging from 0.09 to 0.5 μL/mL, and wherein in said step (iii) or (iii′) the depositing is accomplished by inkjet printing.

19. The method of claim 16, wherein said second composition comprises BSA in an amount equal to 128 mg/mL, GOx in an amount equal to 16 mg/mL, and CAT in an amount equal to 32 mg/mL, and wherein in said step (iii) or (iii′) the depositing is accomplished by extrusion printing.

20. The method of claim 1, wherein said second composition further comprises an amount of a cross-linking agent comprised between 0.5 and 5 μL/mL of a 25 wt. % GDA solution.

21. The method of claim 12, wherein the method comprises said step (iii′) and wherein, in said step (iii′), said first and second compositions are pre-mixed resulting in a pre-mixture comprising GDA in an amount ranging from 1 to 40 μL/mL of a 25 wt. % GDA solution in water, Pluronic F-127 in an amount ranging from 5 to 300 mg/mL, BSA in an amount ranging from 15 to 250 mg/mL, GOx in an amount ranging from 2 to 32 mg/mL, and CAT in an amount ranging from 4 to 64 mg/mL.

22. The method ace of claim 1, wherein, in step (iii) or (iii′), said compositions or pre-mixture are deposited by providing between about 1 and 100 nL of said compositions or pre-mixture per mm² area onto the substrate.

23-25. (canceled)

26. The method of claim 1, wherein said cross-linked matrix is a hydrogel.

27-29. (canceled)

30. The method of claim 1, wherein said depositing is carried out in such a way that a predefined pattern of said cross-linked matrix is formed onto said substrate, wherein said pattern is in the form of one or more lines, strips, grids, circles, films, layers, and/or spots.

31. The method of claim 30, wherein said pattern is in the form of a homogeneous film.

32-35. (canceled)

36. A cross-linked active matrix formed on a substrate obtained by the method of claim 1.

37. A kit comprising a first fluid composition comprising at least one cross-linking agent and a second fluid composition comprising at least one or more active molecules or biomolecules capable of cross-linking with said cross-linking agent, wherein said e or more active molecules or biomolecules comprise one or more enzymes capable of catalyzing the reduction of oxygen.

38-43. (canceled)
